(19) United States
(12) Patent Application Publication
(10) Pub. No.: US 2013/0102346 A1
(43) Pub. Date: Apr. 25, 2013

(54) INFORMATION PROCESSING APPARATUS, WIRELESS COMMUNICATION APPARATUS, COMMUNICATION SYSTEM, AND CONTROL METHOD FOR INFORMATION PROCESSING APPARATUS

(71) Applicant: Tadashi Ehara, Kanagawa (JP)

(72) Inventor: Tadashi Ehara, Kanagawa (JP)

(73) Assignee: Sony Corporation, Tokyo (JP)

(21) Appl. No.: 13/608,477

(22) Filed: Sep. 10, 2012

(30) Foreign Application Priority Data
Oct. 20, 2011 (JP) 2011-230926

(51) Int. Cl. H04W 60/00

(52) U.S. Cl. 455/517

(57) ABSTRACT

An information processing apparatus includes an obtaining unit and a controller. The obtaining unit obtains, upon receiving, from a wireless communication apparatus which belongs to a group constituted by a plurality of wireless communication apparatuses that share a connection right to connect to a predetermined network by utilizing wireless communication, a registration request to register device identification information for identifying the wireless communication apparatus, device identification information for identifying the plurality of wireless communication apparatuses which belong to the group to which the wireless communication apparatus that has sent the registration request belongs, from a management system which manages the group. The controller performs control so that the obtained device identification information and login information are stored in a storage unit in association with each other, the login information being used when a wireless communication apparatus corresponding to the device identification information utilizes a communication service.

### BACKGROUND

The present technology relates to an information processing apparatus, and more specifically, to an information processing apparatus connected to a network, a wireless communication apparatus, a communication system including the information processing apparatus and the wireless communication apparatus, and a control method for the information processing apparatus.

Currently, in the Third Generation Partnership Project (3GPP) which produces technical specifications of public radio communication networks, the feature extension is being examined (for example, see 3GPP TR 33.812 V9.2.0 (2010-06)).

The feature extension (referred to as “Machine to Machine Equipment”) makes it possible to flexibly utilize information concerning contract authentication. The information concerning contract authentication is indicated by a Machine Communication Identity Module (MCIM). For example, a MCIM can be downloaded from a network, temporarily stopped, or restarted.

Currently, it is necessary to store information corresponding to a MCIM in a physical device called a Subscriber Identity Module (SIM) card. However, by treating a MCIM as software, the storage form of MCIM information may become flexible.

### SUMMARY

By utilizing the above-described feature extension, a MCIM may be used in a manner different from that in the related art.

For example, the use of the same MCIM among a plurality of wireless communication apparatuses may be considered. In this case, wireless communication apparatuses that share the same MCIM are able to use a desired communication service. However, if a communication service desired by a user involves a login operation, it may not be possible for the user to immediately log in to the service even by using a wireless communication apparatus in which a MCIM is set. Accordingly, under a situation in which a plurality of wireless communication apparatuses share the same MCIM, it will be convenient if it is possible for a user to easily receive a desired communication service.

In view of the above-described background, it is desirable to easily receive a user's favorite communication service.

An information processing apparatus, a control method therefor, a program allowing a computer to execute the control method, and a recording medium storing the program therein according to an embodiment of the present technology include: an obtaining unit configured to obtain, upon receiving, from a wireless communication apparatus which belongs to a group constituted by a plurality of wireless communication apparatuses that share a connection right to connect to a predetermined network by utilizing wireless communication, a registration request to register device identification information for identifying the wireless communication apparatus, device identification information for identifying the plurality of wireless communication apparatuses which belong to the group to which the wireless communication apparatus that has sent the registration request belongs, from a management system which manages the group; and a controller configured to perform control so that the obtained device identification information and login information are stored in a storage unit in association with each other, the login information being used when a wireless communication apparatus corresponding to the device identification information utilizes a communication service.

In the above-described embodiment, upon receiving a supply request to supply the login information from a wireless communication apparatus which belongs to the group, the controller may supply the login information associated with device identification information for identifying the wireless communication apparatus that has sent the supply request.

In the above-described embodiment, the supply request may include the device identification information; the management system may store group identification information for identifying a group and the device identification information concerning each of wireless communication apparatuses which belong to the group corresponding to the group identification information in association with each other; the obtaining unit may obtain, upon receiving the registration request, group identification information and the associated device identification information, the group identification information concerning the group to which the wireless communication apparatus that has sent the registration request belongs; and the controller may perform control so that the obtained device identification information and the obtained group identification information are stored in association with each other, and when supplying the login information to the wireless communication apparatus that has sent the supply request, the controller may detect group identification information concerning a group to which the wireless communication apparatus that has sent the supply request belongs, on the basis of device identification information included in the supply request, and may send login information associated with the detected group identification information to the wireless communication apparatus that has sent the supply request.

In the above-described embodiment, the information processing apparatus may be a server that provides a sending service for sending the login information to the wireless communication apparatus; and in response to a login request to receive the provision of the sending service, the obtaining unit may obtain the group identification information and the device identification information if authentication information for changing group information concerning a group to be managed by the management system is supplied.

In the above-described embodiment, the management system may be a registration operator (RO); and the obtaining unit may obtain, as the device identification information, a provisional connectivity identity (PCID) used for connecting to the registration operator.

An information processing apparatus according to another embodiment of the present technology includes: a storage unit configured to store group identification information and login information in association with each other, the group identification information being used for identifying a group constituted by a plurality of wireless communication apparatuses that share a connection right to connect to a predetermined network by utilizing wireless communication, the login information being used when a wireless communication apparatus which belongs to the group corresponding to the group identification information utilizes a communication service; a sending unit configured to send, upon receiving a supply request to supply the login information from a wireless communication apparatus which belongs to the group, device identification information for identifying the wireless communication apparatus, the device identification information being included in the supply request, to a management system in which the group identification information and device identification information concerning each of the wireless communication apparatuses which belong to a group corresponding to the group identification information are stored in association with each other; and a controller configured to perform control so that, by using group identification information corresponding to the group to which the wireless communication apparatus that has sent the supply request belongs, the group identification information being supplied from the management system in response to the device identification information sent by the sending unit, login information associated with the group identification information is sent to the wireless communication apparatus that has sent the supply request.

A wireless communication apparatus according to still another embodiment of the present technology includes: a first controller configured to perform control so that a supply request to supply login information concerning a communication service which involves a login operation when using the communication service, the supply request including device identification information for identifying a wireless communication apparatus, is sent to an information processing apparatus in which the login information and group identification information are stored in association with each other, the group identification information being used for identifying a group constituted by a plurality of wireless communication apparatuses that share a connection right to connect to a predetermined network by utilizing wireless communication; and a second controller configured to perform control so that, upon receiving, from the information processing apparatus, login information associated with group identification information which has been detected on the basis of the device identification information included in the supply request, a login operation for logging in to the communication service is performed on the basis of the received login information, and then, data concerning the use of the communication service is sent and received.

A communication system according to a yet another embodiment of the present technology includes: a management server configured to store group identification information and device identification information in association with each other for each wireless communication apparatus, the group identification information being used for identifying a group constituted by a plurality of wireless communication apparatuses that share a connection right to connect to a predetermined network by utilizing wireless communication, the device identification information being used for identifying each of the wireless communication apparatuses which belong to the group corresponding to the group identification information, and the management server being configured to manage the group; an information processing apparatus configured to perform control so that, upon receiving a registration request to obtain the group identification information from a wireless communication apparatus which belongs to the group, the group identification information and the device identification information are obtained from the management server, and so that the obtained group identification information and the obtained device identification information are stored in a storage unit in association with login information which is used when a wireless communication apparatus which belongs to the group corresponding to the obtained group identification information utilizes a communication service; and a wireless communication apparatus configured to perform control so that, when utilizing the communication service, a registration request to register login information, the registration request including device identification information, is sent to the information processing apparatus, and so that, upon receiving login information which has been detected on the basis of the device identification information from the information processing apparatus, a login operation for logging in to the communication service is performed on the basis of the received login information, and then, data concerning the use of the communication service is sent and received.

According to an embodiment of the present technology, it is possible to easily receive a user's favorite communication service.

### BRIEF DESCRIPTION OF THE DRAWINGS

FIGS. 1A and 1B schematically illustrate an example of a use of a plurality of wireless communication apparatuses according to a first embodiment of the present technology;

FIGS. 2A and 2B are block diagrams illustrating an example of a system configuration of a communication system according to the first embodiment;

FIG. 3 is a block diagram illustrating an example of a system configuration of another communication system according to the first embodiment;

FIG. 4 schematically illustrates a group management database in the first embodiment;

FIG. 5 schematically illustrates a profile database stored in a profile storage unit in the first embodiment;

FIG. 6 is a block diagram illustrating an example of the internal configuration of a first wireless communication apparatus in the first embodiment;

FIG. 7 illustrates an example of a login screen displayed in a first wireless communication apparatus when logging in to a device management system in the first embodiment;

FIG. 8 illustrates an example of a register screen displayed in the first wireless communication apparatus when registering an account in the device management system in the first embodiment;

FIGS. 9A through 9C schematically illustrate a process for obtaining group information from a communication control apparatus (type I carrier) by an information processing apparatus (first service provider) in the first embodiment;

FIGS. 10A through 10C schematically illustrate a process for registering service login information by using the first wireless communication apparatus in the first embodiment;

FIGS. 11A through 11C schematically illustrate a process for using a service of an information processing apparatus (second service provider) by using a second wireless communication apparatus in the first embodiment;

FIGS. 12 and 13 are sequence charts illustrating an example of communication processing performed among the apparatuses forming the communication system of the first embodiment when login information is registered in a profile;

FIGS. 14 and 15 are sequence charts illustrating an example of communication processing performed among the apparatuses forming the communication system in the first embodiment when a service is used by obtaining login information;

FIG. 16 is a sequence chart illustrating an example of communication processing performed when transferring a MCIM among the apparatuses forming the communication system in the first embodiment;

FIG. 17 is a flowchart illustrating an example of a procedure for communication processing performed by the first wireless communication apparatus when setting management subject service login information in the first embodiment;

FIG. 18 is a flowchart illustrating an example of a procedure for communication processing performed by the information processing apparatus (first service provider) when setting a management subject service in the first embodiment;

FIG. 19 is a flowchart illustrating an example of a procedure for communication processing performed by the second wireless communication apparatus when uploading data (photo);

FIG. 20 is a flowchart illustrating an example of a procedure for communication processing performed by the information processing apparatus (first service provider) when uploading data (photo) in the first embodiment; and

FIG. 21 is a sequence chart illustrating an example of communication processing performed among the apparatuses forming a communication system in a second embodiment when a service is used by obtaining login information.

### DETAILED DESCRIPTION OF EMBODIMENTS

Embodiments of the present technology will be described below with reference to the accompanying drawings. A description will be given in the following order.

1. First Embodiment (Wireless Communication Control: an example in which login information associated with a MCIM group is supplied to a wireless communication apparatus)

2. Second Embodiment (Wireless Communication Control: an example in which information concerning a group is obtained from a registration operator (RO) every time login information is supplied to a wireless communication apparatus)

### 1. First Embodiment

### [Example of Usage of Wireless Communication Apparatus]

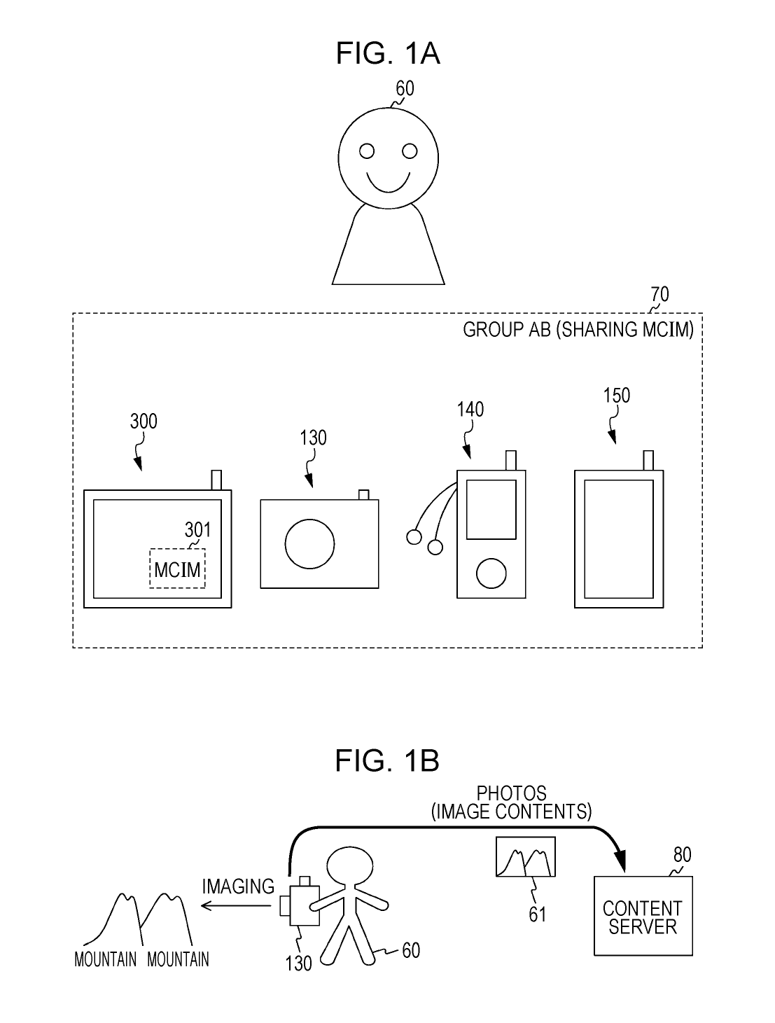

FIGS. 1A and 1B schematically illustrate an example of the usage of a plurality of wireless communication apparatuses (devices) according to a first embodiment of the present technology.

FIG. 1A illustrates four wireless communication apparatuses (first, second, third, and fourth wireless communication apparatuses 300, 130, 140, and 150) owned by a user 60.

The first wireless communication apparatus 300 (e.g., a tablet device or a notebook personal computer (PC)) is a wireless communication apparatus including a web browser and implementing easy text input. The second wireless communication apparatus 130 is an imaging apparatus (e.g., a digital still camera or a digital video camera (camcorder)) including a wireless communication function. The third wireless communication apparatus 140 is an audio output apparatus (e.g., a portable audio player) including a wireless communication function. The fourth wireless communication apparatus 150 is a mobile phone (e.g., a smartphone including a verbal communication function and a data communication function). These wireless communication apparatuses are examples of wireless communication apparatuses which can use a software downloadable SIM. Another wireless communication apparatus which can use a software downloadable SIM (e.g., an e-book reader including a wireless communication function) may be utilized. Additionally, an information processing apparatus (e.g., a PC without a wireless communication function) which performs wireless communication by attaching a wireless communication device including a wireless communication function thereto may be utilized.

The four wireless communication apparatuses belong to a group (group name: group AB) that shares a connection right to connect to a predetermined network. This connection right may be identified as a right to use a MCIM (also called a MCIM usage right).

MCIM is an example of contract authentication information, and the contract authentication information includes a telephone subscriber information and authentication information. MCIM is contract authentication information (so-called software SIM) that allows a user to flexibly set a telecommunication carrier (e.g., a mobile phone company) after purchase without having to select a specific telecommunication carrier when the user purchases a device. Additionally, a user is able to rewrite a MCIM through the use of a network. It is thus easy to separate the market of mobile phone sets from the selection of telecommunication carriers and also to facilitate easy sharing of contract authentication information among a plurality of wireless communication apparatuses. If a wireless communication apparatus does not possess a MCIM usage right, it means that a wireless communication apparatus does not possess a MCIM itself, or that the wireless communication apparatus only possesses a MCIM which has been invalidated by performing invalidating processing.

FIG. 1B schematically illustrates that the user 60 performs imaging by using the second wireless communication apparatus 130.

It can be assumed, in this case, that it is less likely that the second wireless communication apparatus 130 (e.g., a camera) will perform communication processing by connecting to a network, such as the Internet. Accordingly, it is not necessary to constantly connect the second wireless communication apparatus 130 to a network. The user 60 may connect the second wireless communication apparatus 130 to a network, such as the Internet, when the user 60 takes photographs in an event, such as a sports festival, in order to upload the photographs in a content server 80.

That is, in most cases, a device, such as the wireless communication apparatus 130, may be set in a restricted connection state under the normal conditions and, when necessary, it is allowed to temporarily utilize a MCIM usage right.

In most cases, a device, such as the second wireless communication apparatus 130, does not include a web browser, and thus, it is not possible for the device to register in, for example, a network service of the content server 80. Additionally, in order to log in to a network service, it is necessary that both of a device, such as the wireless communication apparatus 130, and the content server 80, support a login operation. It is thus convenient if a device, such as the wireless communication apparatus 130, can easily utilize a network service.

Accordingly, in the first embodiment, login information (account information) concerning network services are managed in units of groups, each group constituted by a plurality of wireless communication apparatuses that share a MCIM, thereby facilitating the use of network services by the wireless communication apparatuses.

### [Example of Configuration of Communication System]

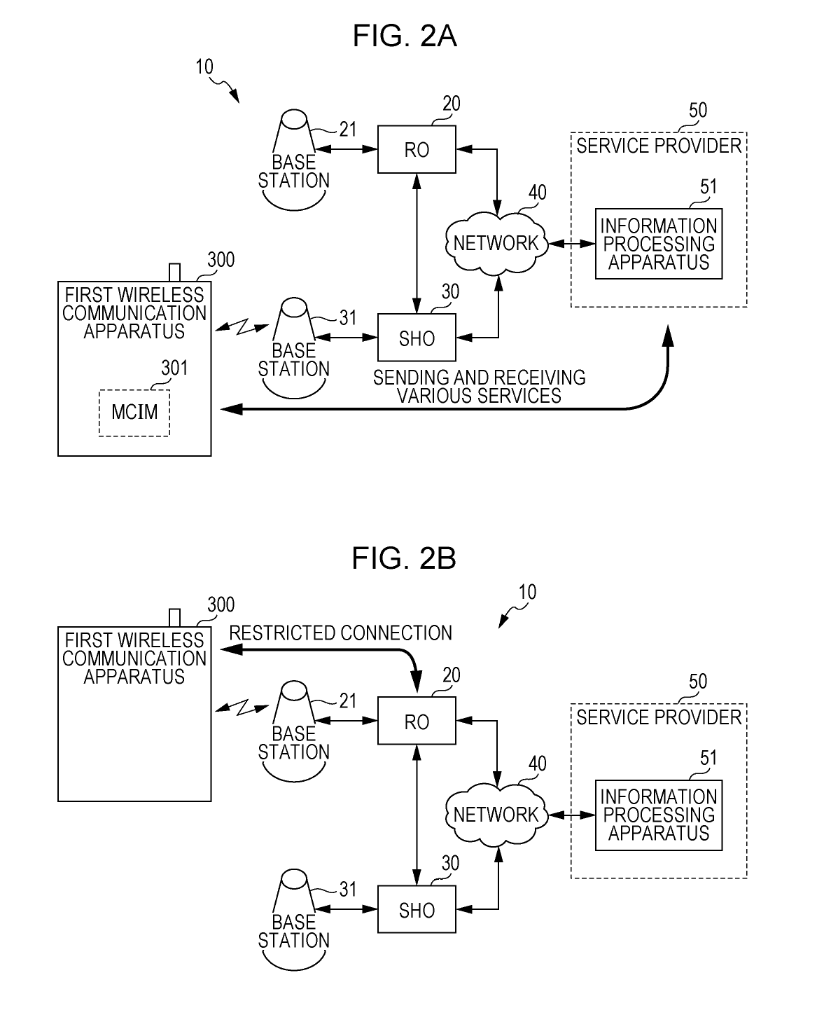

FIGS. 2A and 2B are block diagrams illustrating an example of a system configuration of a communication system 10 according to the first embodiment. In the example of the system configuration shown in FIGS. 2A and 2B, it is assumed that the network configuration includes a selected home operator (SHO) and a registration operator (RO) (for example, see 3GPP TR 33.812 V9.2.0 (2010-06)).

FIG. 2A illustrates an example of wireless communication performed when the first wireless communication apparatus 300 possesses a valid MCIM (MCIM usage right) 301. FIG. 2B illustrates an example of wireless communication performed when the wireless communication apparatus 300 does not possess the valid MCIM (MCIM usage right) 301.

The communication system 10 includes a RO 20, a SHO 30, base stations 21 and 31, a network 40, an information processing apparatus 51, and the first wireless communication apparatus 300.

The RO 20 and the SHO 30, which serve as logical functions, may be utilized by different carriers or by the same carrier. A plurality of ROs 20 and SHOs 30 may be provided. Additionally, the RO 20 and the SHO 30 may be integrated as an information processing apparatus, or they may be constituted by a plurality of apparatuses. In this case, the RO 20 or the SHO 30 serves as a relative function in terms of a wireless communication apparatus including a valid MCIM. Accordingly, an operator may serve as the RO 20 as viewed from one wireless communication apparatus, but it may serve as the SHO 30 as viewed from another wireless communication apparatus.

As shown in FIG. 2A, when the first wireless communication apparatus 300 possesses the valid MCIM 301, it is possible for the first wireless communication apparatus 300 to connect to the SHO 30 via the base station 31 on the basis of the MCIM 301. In contrast, as shown in FIG. 2B, when the first wireless communication apparatus 300 does not possess the valid MCIM 301, it is not possible for the first wireless communication apparatus 300 to connect to the SHO 30. In this case, however, the first wireless communication apparatus 300 can connect to the RO 20 via the base station 21 on the basis of a provisional connectivity identity (PCID).

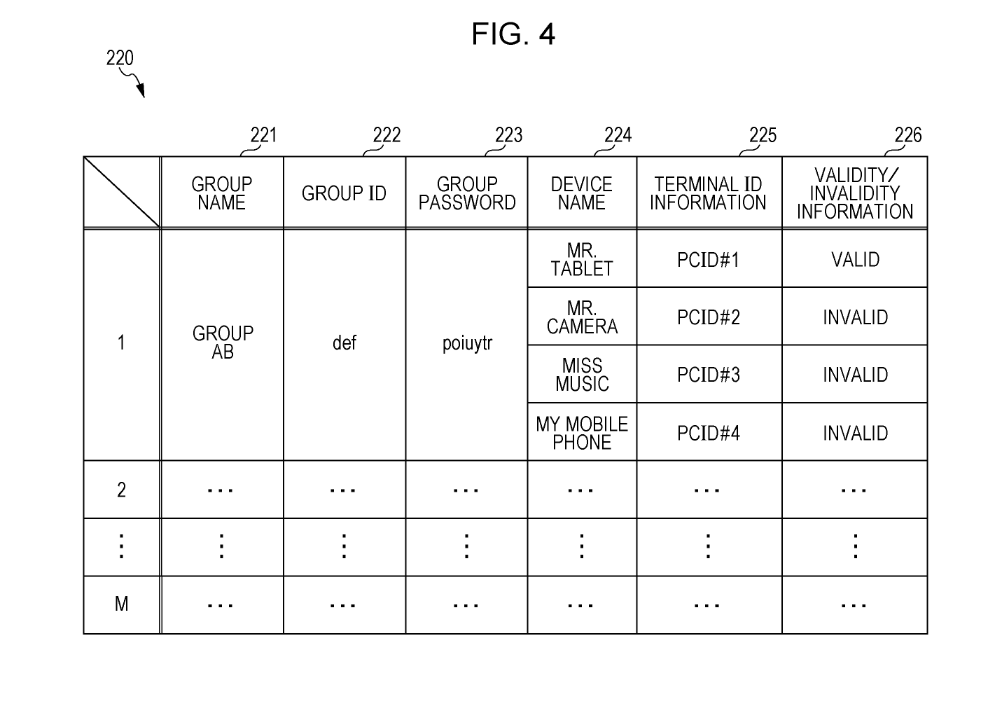

The PCID is an identifier (e.g., terminal identification (ID) information 225 in a network shown in FIG. 4) for connecting to a RO. The PCID is provided to all wireless communication apparatuses (devices) having a software downloadable SIM mechanism.

The network 40 is a network (e.g., a public network), such as a telephone network or the Internet. The network 40 and the SHO 30 are connected to each other via a gateway (not shown). Similarly, the RO 20 and the network 40 are connected to each other via a gateway (not shown).

The RO 20 is a communication control apparatus managed by a wireless carrier that provides services, such as initial connection registration. The RO 20 corresponds to a wireless carrier (e.g., a mobile phone company) that provides wireless connection services. The RO 20 includes a controller (not shown).

The controller of the RO 20 performs authentication control of a wireless communication apparatus connected to the RO 20 via the base station 21. For example, the controller of the RO 20 performs authentication of a wireless communication apparatus connected to the RO 20 via the base station 21 on the basis of a PCID. The RO 20 then provides services, such as initial connection registration, to an authenticated wireless communication apparatus. The controller of the RO 20 is connected to the SHO 30 and sends and receives various items of information to and from the SHO 30.

The base station 21 is a mobile communication base station (Node B) that connects the first wireless communication apparatus 300 to the RO 20 via a wireless network.

The SHO 30 is a communication control apparatus managed by a wireless carrier that provides wireless connection services. The SHO 30 provides Internet services, etc., and corresponds to a wireless carrier (e.g., a mobile phone company) that provides wireless connection services. The SHO 30 includes a controller (not shown).

The controller of the SHO 30 performs authentication control of a wireless communication apparatus connected to the SHO 30 via the base station 31. For example, the controller of the SHO 30 performs authentication of a wireless communication apparatus that possesses a valid MCIM (contract authentication information) of the SHO 30 among wireless communication apparatuses connected to the SHO 30 via the base station 31. The SHO 30 then connects an authenticated wireless communication apparatus to the network 40 via a gateway (not shown).

The controller of the SHO 30 is connected to the RO 20 and sends and receives various items of information to and from the RO 20. With this operation, a wireless communication apparatus that does not possess a valid MCIM can be connected to the RO 20 via the SHO 30 on the basis of a PCID of the wireless communication apparatus (restricted connection).

The base station 31 is a mobile communication base station (Node B) that connects the first wireless communication apparatus 300 to the SHO 30 via a wireless network.

A service provider 50 is a company (service provider (SP)) that provides various communication services, such as content storage services and content distribution services. The service provider 50 includes the information processing apparatus 51 for providing these communication services. The information processing apparatus 51 is connected to the RO 20 and the SHO 30 via the network 40. As the carrier that provides various communication services, a communication carrier that provides wireless connection services, e.g., a carrier in a business form called a virtual communication carrier (so-called “mobile virtual network operator (MVNO)”) is assumed.

The information processing apparatus 51 provides various communication services via the network 40, and more specifically, it provides various communication services, such as web services, data download services, data upload services, and online games, to the first wireless communication apparatus 300 by using wireless communication.

For example, if the first wireless communication apparatus 300 possesses the valid MCIM 301, as shown in FIG. 2A, it is connected to the base station 31 via a wireless network on the basis of the MCIM 301, and is connected to the SHO 30 via the base station 31. In this case, the first wireless communication apparatus 300 is connected to the SHO 30 via the base station 31 so as to receive the provision of various services (e.g., downloading of content) from the information processing apparatus 51. When the first wireless communication apparatus 300 that possesses the valid MCIM 301 is connected to the RO 20, it is connected to the RO 20 via the SHO 30.

If the first wireless communication apparatus 300 does not possess the valid MCIM 301, as shown in FIG. 2B, it can be connected to the RO 20 via the base station 21 on the basis of the PCID (restricted connection). In this case, however, although the first wireless communication apparatus 300 is connected to the RO 20 via the base station 21, it can perform only restricted communication (e.g., downloading of MCIM and validating/invalidating of MCIM).

When the first wireless communication apparatus 300 does not possess the valid MCIM 301, it can be connected to either of the base station 21 or 31 in accordance with the position of the first wireless communication apparatus 300, and is connected to the RO 20 via the connected base station.

In this manner, the first wireless communication apparatus 300 which does not possess the valid MCIM 301 is not able to receive the provision of various services from the information processing apparatus 51. That is, a wireless communication apparatus which does not possess a MCIM usage right is identified as a device connected to the RO 20 under restricted service connection (as a RO-connected device). In contrast, a wireless communication apparatus which possesses a MCIM usage right is identified as a device connected to the SHO 30 under normal service connection (as a SHO-connected device). A wireless communication apparatus which does not possess a MCIM usage right obtains a right via the RO 20 (e.g., through downloading or validating of a MCIM), thereby making it possible to connect to the SHO 30. The second, third, and fourth wireless communication apparatuses 130, 140, and 150 are configured in a manner similar to the first wireless communication apparatus 300.

### [Example of Configuration of Communication System]

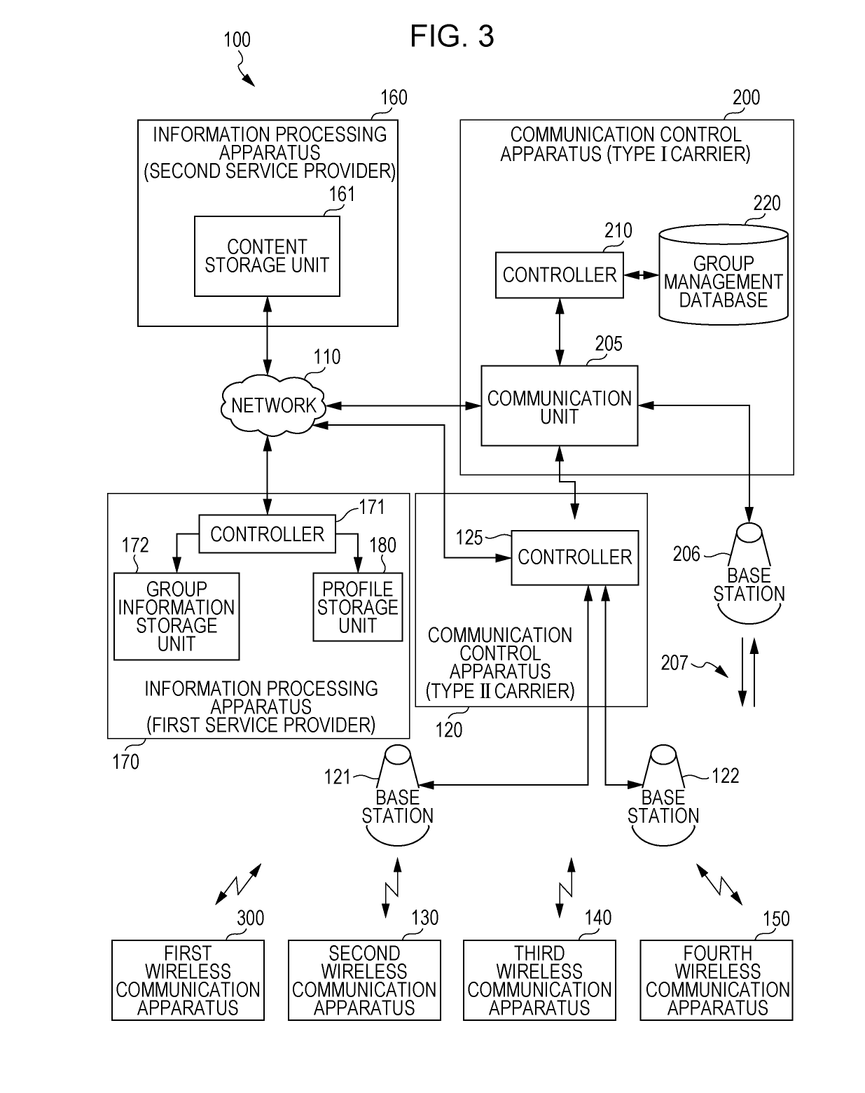

FIG. 3 is a block diagram illustrating an example of a system configuration of a communication system 100 according to the first embodiment.

The communication system 100 includes a network 110, base stations 121, 122, and 206, and the first, second, third, and fourth wireless communication apparatuses 300, 130, 140, and 150. The communication system 100 also includes a communication control apparatus (type II carrier) 120, a communication control apparatus (type I carrier) 200, an information processing apparatus (first service provider) 170, and an information processing apparatus (second service provider) 160.

The communication system 100 is a system corresponding to the communication system 10 shown in FIGS. 2A and 2B. More specifically, the communication control apparatus (type II carrier) 120 corresponds to the SHO 30 shown in FIGS. 2A and 2B, and the communication control apparatus (type I carrier) 200 corresponds to the RO 20 shown in FIGS. 2A and 2B. The information processing apparatus (first service provider) 170, and the information processing apparatus (second service provider) 160 each correspond to the information processing apparatus 51 shown in FIGS. 2A and 2B. Accordingly, in FIG. 3, part of an explanation of the same elements as those of the communication system 10 shown in FIGS. 2A and 2B will be omitted.

The network 110 is a network (e.g., a public network), such as a telephone network or the Internet. The network 110 and the communication control apparatus (type II carrier) 120 are connected to each other via a gateway (not shown). Similarly, the network 110 and the communication control apparatus (type I carrier) 200 are connected to each other via a gateway (not shown).

The communication control apparatus (type II carrier) 120 is managed by a wireless carrier which provides wireless connection services, and corresponds to the SHO 30 shown in FIGS. 2A and 2B. That is, the communication control apparatus (type II carrier) 120 provides services, such as Internet services, and corresponds to a wireless carrier (e.g., a mobile phone company) that provides wireless connection services. The communication control apparatus (type II carrier) 120 includes a controller 125.

The controller 125 performs authentication control of a wireless communication apparatus connected to the communication control apparatus (type II carrier) 120 via the base station 121 or 122. For example, the controller 125 performs authentication of, among wireless communication apparatuses connected to the communication control apparatus (type II carrier) 120 via the base station 121 or 122, a wireless communication apparatus that possesses a valid MCIM (contract authentication information) of the communication control apparatus (type II carrier) 120. The communication control apparatus (type II carrier) 120 then connects an authenticated wireless communication apparatus to the network 110 via a gateway (not shown).

The controller 125 is connected to the communication control apparatus (type I carrier) 200 and sends and receives various items of information to and from the communication control apparatus (type I carrier) 200. With this operation, a wireless communication apparatus that does not possess a valid MCIM can be connected to the communication control apparatus (type I carrier) 200 via the communication control apparatus (type II carrier) 120 on the basis of a PCID of the wireless communication apparatus (restricted connection). Additionally, upon receiving a MCIM transfer request from a wireless communication apparatus, the controller 125 sends the MCIM transfer request to the communication control apparatus (type I carrier) 200.

The base stations 121 and 122 are mobile communication base stations (Node B) which connect the first, second, third, and fourth wireless communication apparatuses 300, 130, 140, and 150 to the communication control apparatus (type II carrier) 120 via a wireless network.

For example, in the communication system 100, a wireless communication apparatus that possesses a valid MCIM is connected to the base station 121 or 122 via a wireless network, and is connected to the communication control apparatus (type II carrier) 120 via the connected base station 121 or 122. When a wireless communication apparatus that possesses a valid MCIM is connected to the communication control apparatus (type I carrier) 200, it is connected to the communication control apparatus (type I carrier) 200 via the communication control apparatus (type II carrier) 120.

A wireless communication apparatus which does not possess a valid MCIM can be connected to the communication control apparatus (type I carrier) 200 via the base station 206 on the basis of the PCID of the wireless communication apparatus (restricted connection). A wireless communication apparatus which does not possess a valid MCIM may be connected to any one of the base stations 121, 122, and 206 in accordance with the position of the wireless communication apparatus, and is connected to the communication control apparatus (type I carrier) 200 via the connected base station.

The communication control apparatus (type I carrier) 200 is managed by a wireless carrier which provides services, such as initial connection registration, and corresponds to the RO 20 shown in FIGS. 2A and 2B. The communication control apparatus (type I carrier) 200 corresponds to, for example, a wireless carrier (e.g., a mobile telephone company) that provides wireless connection services. The communication control apparatus (type I carrier) 200 includes a communication unit 205, a controller 210, and a group management database 220. The communication control apparatus (type I carrier) 200 is an example of a management system or a management server.

The communication unit 205 sends and receives various items of information under the control of the controller 210. The communication unit 205 is connected to the communication control apparatus (type II carrier) 120 or the base station 206, and sends and receives various items of information to and from a wireless communication apparatus connected to the communication control apparatus (type II carrier) 120 or the base station 206.

The controller 210 performs various types of control operations concerning a wireless communication apparatus connected to the communication control apparatus (type I carrier) 200 via the communication unit 205 (or the communication unit 205 and the communication control apparatus (type II carrier) 120). For example, the controller 210 obtains, from the group management database 220, information (group information) concerning a group constituted by a plurality of wireless communication apparatuses that share a MCIM usage right. The controller 210 then supplies the obtained group information to the connected wireless communication apparatus via the communication unit 205 and the communication control apparatus (type II carrier) 120.

By transferring a MCIM usage right among a plurality of wireless communication apparatuses, it is possible for them to share the MCIM. In this case, the plurality of wireless communication apparatuses that share the same MCIM may be set as one group. This group is managed by the group management database 220.

This group is a group which shares a connection right (network connection right). The connection right is a right to connect to a predetermined network (e.g. the network 110) by using wireless communication, and corresponds to, for example, the right to use a MCIM. That is, the connection right is a right to connect to a base station run by a communication carrier on the basis of a MCIM (contract authentication information) used for connecting to the base station. The presence or absence of a connection right corresponds to the presence or absence of a MCIM usage right.

The group management database 220 is a database for managing groups, each being constituted by a plurality of wireless communication apparatuses that share a MCIM. A detailed description of the group management database 220 will be given later with reference to FIG. 4.

A description will now be given of an example in which a MCIM usage right (network connection right) is transferred in the communication system 100. For example, a MCIM is stored in each wireless communication apparatus. Then, in response to an instruction from the controller 210, the communication control apparatus (type II carrier) 120 validates or invalidates a MCIM stored in each wireless communication apparatus, thereby making it possible to transfer a MCIM usage right. It is noted that, instead of the communication control apparatus (type II carrier) 120, the communication control apparatus (type I carrier) 200 may validate/invalidate a MCIM stored in each wireless communication apparatus. In this case, the controller 210 may validate/invalidate a MCIM stored in each wireless communication apparatus so as to transfer a MCIM usage right.

Alternatively, in order to transfer a MCIM usage right, instead of storing a MCIM in each wireless communication apparatus and validating or invalidating a MCIM, a MCIM itself may be transferred. For example, it is now assumed that a MCIM usage right is transferred from the first wireless communication apparatus 300 to the second wireless communication apparatus 130. A MCIM transfer request is sent from the first wireless communication apparatus 300 to the controller 210. In this case, in response to an instruction from the controller 210, the MCIM stored in the first wireless communication apparatus 300 is invalidated (erased) by the communication control apparatus (type II carrier) 120. Then, under the control of the controller 210, setting information (including the MCIM) is sent from the communication control apparatus (type II carrier) 120 to the second wireless communication apparatus 130. The MCIM included in the setting information is stored in the second wireless communication apparatus 130, thereby setting a valid MCIM in the second wireless communication apparatus 130. It is noted that the communication control apparatus (type I carrier) 200 may send setting information (including a MCIM) to a wireless communication apparatus. In this case, the controller 210 may send setting information (including a MCIM) to a wireless communication apparatus, thereby transferring a MCIM usage right.

The information processing apparatus (first service provider) 170, and the information processing apparatus (second service provider) 160 are information processing apparatuses (e.g., content servers) that provide various communication services via the network 110, and provide various communication services to wireless communication apparatuses by using wireless communication. For example, the information processing apparatus (second service provider) 160 includes a content storage unit 161 and provides an online storage service.

The information processing apparatus (first service provider) 170 is an information processing apparatus that provides a device management system. The device management system is a service for allowing a plurality of wireless communication apparatuses to utilize a service for which login information (login ID (account ID) and login password (account password)) is necessary. The information processing apparatus (first service provider) 170 has the function of storing login information of a communication service and a group which shares a connection right in association with each other. In response to a request from a wireless communication apparatus, the information processing apparatus (first service provider) 170 supplies stored login information to the wireless communication apparatus. The information processing apparatus (first service provider) 170 includes a controller 171, a group information storage unit 172, and a profile storage unit 180.

The controller 171 controls communication performed by the information processing apparatus (first service provider) 170. For example, upon receiving a login ID and a login password of the information processing apparatus (first service provider) 170 from a wireless communication apparatus, the controller 171 refers to registration information (profile) stored for each user in the profile storage unit 180, and checks whether the user of the wireless communication apparatus has been registered for a service provided by the information processing apparatus (first service provider) 170.

Upon receiving information (group ID and group password) necessary for accessing group information from a wireless communication apparatus, the controller 171 sends a group information request to the communication control apparatus (type I carrier) 200. The group information request is information for making a request to send group information, and includes at least a group ID and a group password. Upon receiving the group information request, the controller 210 of the communication control apparatus (type I carrier) 200 obtains, from the group management database 220, group information specified by the group ID and the group password contained in the group information request. Then, the controller 210 sends the obtained group information to the controller 171 of the information processing apparatus (first service provider) 170. The controller 171 is an example of an obtaining unit, a controller, or a sending unit.

The group information storage unit 172 stores group information supplied from the communication control apparatus (type I carrier) 200. The information processing apparatus (first service provider) 170 detects a group to which a wireless communication apparatus belongs, by using the stored group information. In the first embodiment, for the sake of description, an example in which group information is stored is described. However, information (terminal identification (ID) information) for identifying a wireless communication apparatus which belongs to a group and group ID information (e.g., a group ID) may be stored. That is, in the group information storage unit 172, a list of wireless communication apparatuses which belong to each group is stored, and the information processing apparatus (first service provider) 170 detects a group to which a wireless communication apparatus belongs, by using this list.

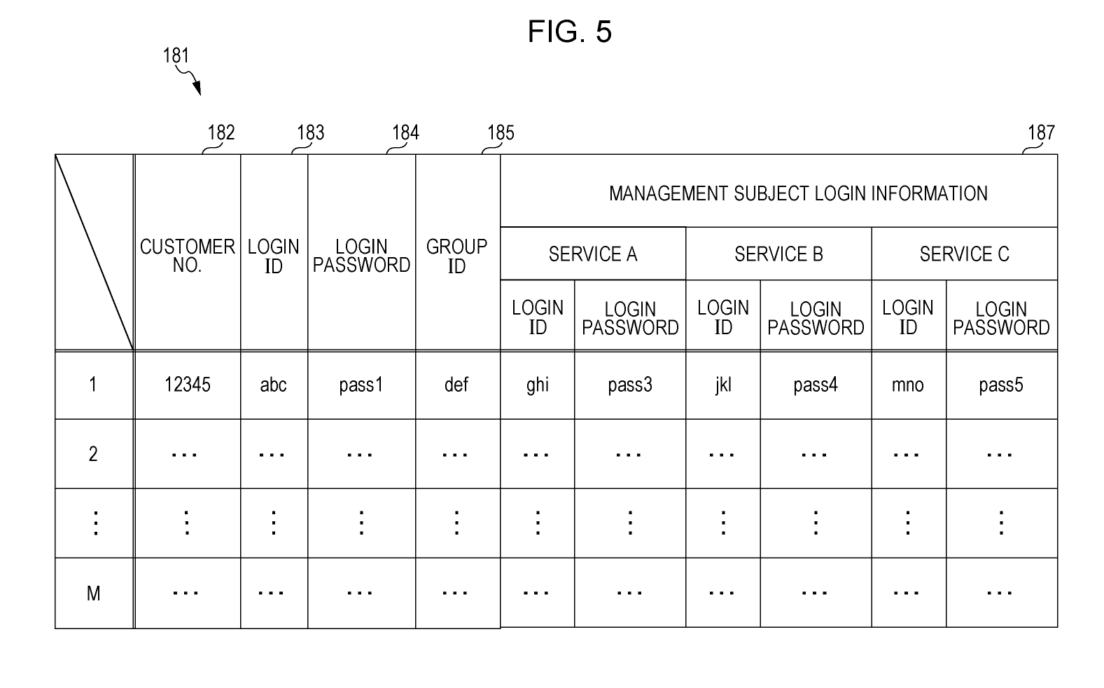

The profile storage unit 180 stores information (profile) concerning users registered in a service provided by the information processing apparatus (first service provider) 170. For example, the profile storage unit 180 stores profiles of a plurality of users as a database. In the profile stored by the profile storage unit 180, user account information is registered. In this profile, at least user group ID information (group ID) and login information concerning a service provided to wireless communication apparatuses which belong to a group that shares a connection right (network connection right) are registered in association with each other. The profile stored in the profile storage unit 180 will be discussed later with reference to FIG. 5, and an explanation thereof is omitted here. The login information is supplied to a wireless communication apparatus in response to a request from the wireless communication apparatus.

### [Example of Configuration of Group Management Database]

FIG. 4 schematically illustrates the group management database 220 used in the first embodiment.

In the example of the group management database 220 shown in FIG. 4, the first, second, third, and fourth wireless communication apparatuses 300, 130, 140, and 150 are registered in the group AB.

The group management database 220 includes a group name 221, a group ID 222, a group password 223, a device name 224, terminal ID information 225, and validity/invalidity information 226 in association with one another for each group. These items of information are sequentially updated by the controller 210 on the basis of a request (group addition request or group deletion request) from a wireless communication apparatus.

In the group name 221, a name assigned to a group is stored. A name is stored, for example, when a group is created.

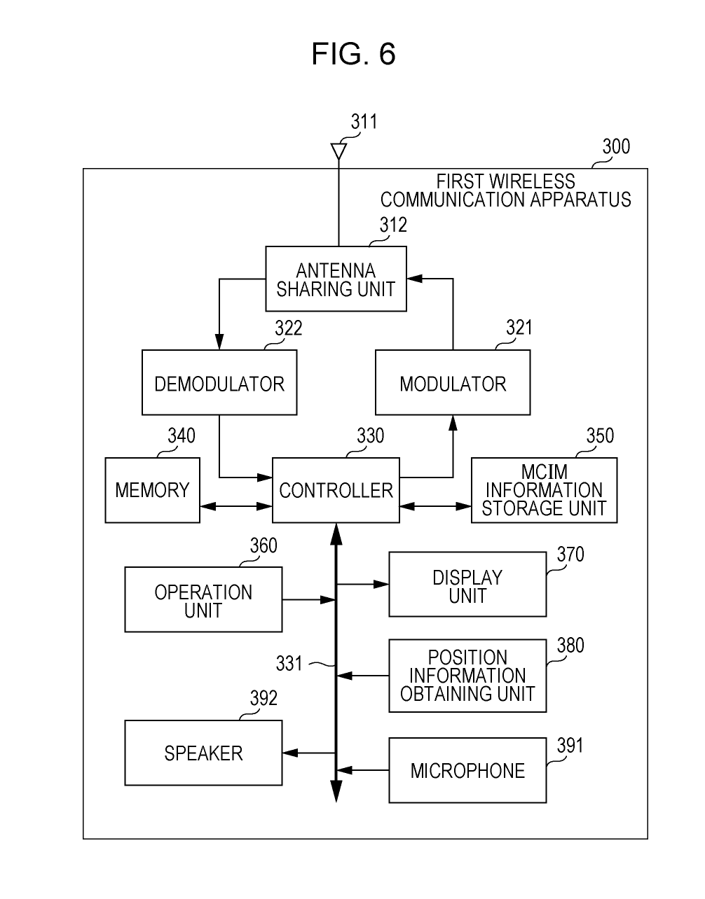

In the group ID 222, an ID assigned to a group is stored. In the group password 223, a password assigned to a group is stored. By using the ID and the password, for example, a group addition request to add a new wireless communication apparatus is made. That is, the ID and the password are authentication information used for changing information for specifying a group. Each of the wireless communication apparatuses which belong to a group may store the ID and the password assigned to the group, for example, in a memory 340 of the first wireless communication apparatus 300 shown in FIG. 6. Alternatively, instead of allowing a user to store the ID and the password in a wireless communication apparatus, an instruction may be given to the user to input the ID and the password every time the user wishes to receive a service.

In the device name 224, a name assigned to a device is stored. A name is stored, for example, when a new wireless communication apparatus is registered in a group.

In the terminal ID information 225, a terminal ID number of a wireless communication apparatus (device) is stored. The terminal ID information 225 is information used for identifying a wireless communication apparatus, and a PCID, for example, is stored. In the example shown in FIG. 4, “PCID #1”, “PCID #2”, “PCID #3”, and “PCID #4” stored in the terminal ID Information 225 correspond to the first, second, third, and fourth wireless communication apparatuses 300, 130, 140, and 150, respectively.

In the validity/invalidity information 226, information indicating whether a MCIM of a wireless communication apparatus is valid or invalid (or a MCIM is valid or is not stored) is stored. In FIG. 4, for the sake of simple description, “valid” is indicated for a wireless communication apparatus having a valid MCIM, and “invalid” is indicated for a wireless communication apparatus having an invalid MCIM.

In this manner, in the group management database 220, a group constituted by a plurality of wireless communication apparatuses which share a MCIM is managed. In the first embodiment, it is assumed that a MCIM is transferred among wireless communication apparatuses which belong to the same group.

Registration of a wireless communication apparatus in a group will be discussed below. For example, a new wireless communication apparatus performs a registration operation so that it can be registered in a group. In this case, the new wireless communication apparatus may be registered, on the condition that one or a plurality of wireless communication apparatuses registered in the same group as the new wireless communication apparatus approve of the registration of the new wireless communication apparatus.

In the first embodiment, for the sake of simple description, it is assumed that a group constituted by a plurality of wireless communication apparatuses shares one MCIM. However, a case in which a group constituted by M wireless communication apparatuses share N MCIMs (M>N) may be similarly applied.

The group information discussed with reference to FIG. 4 is sent to the information processing apparatus (first service provider) 170 in response to a request from the information processing apparatus (first service provider) 170. More specifically, group information is searched for, on the basis of the group ID 222 and the group password 223, which are supplied together with a request from the information processing apparatus (first service provider) 170, and then, the searched group information is sent to the information processing apparatus (first service provider) 170. In the first embodiment, an example in which group information is sent to the information processing apparatus (first service provider) 170 will be discussed. However, as discussed with reference to FIG. 3, only the group ID 222 and the terminal ID information 225 may be sent.

### [Example of Configuration of Profile Database in Profile Storage Unit]

FIG. 5 schematically illustrates a profile database 181 stored in the profile storage unit 180 of the information processing apparatus (first service provider) 170 in the first embodiment.

In FIG. 5, a description will be given by focusing on the profile of a user having a user number (customer No.) “12345”. In FIG. 5, a description will also be given, assuming that the group information concerning this user is already stored in the group information storage unit 172.

It is also assumed that the number of services for which items of login information are stored in association with the group information is three. It is also assumed that the user having a customer No. “12345” has already registered items of login information for all the services (service A, service B, and service C).

The profile database 181 includes a customer No. 182, a login ID 183, a login password 184, a group ID 185, and management subject login information 187 in association with one another for each user (for each customer number). These items of information other than the customer No. 182 may be updated as a result of a user performing an operation by using a wireless communication apparatus that can access the login system of the information processing apparatus (first service provider) 170 via a web site. An example of such a wireless communication apparatus is an apparatus which can start a web browser.

The customer No. 182 is a number assigned to each user registered in the device management system.

The login ID 183 is an ID used for a user registered in the device management system to log in to the device management system.

The login password 184 is a password used for a user registered in the device management system to log in to the device management system.

The group ID 185 is an ID of a group which shares a connection right (network connection right) and to which a wireless communication apparatus owned by a user registered in the device management system belongs. That is, the group ID 185 corresponds to the group ID 222 shown in FIG. 4.

The management subject login information 187 is login information (login ID and login password of a management subject service) concerning a service for which an account is managed (hereinafter may simply referred to as an “account service”), i.e., login information concerning a service used by a wireless communication apparatus which belongs to the associated group. If there are a plurality of services used by a wireless communication apparatus which belongs to the associated group, login information concerning each of the services (e.g., service A, service B, and service C) is stored.

In this manner, in the profile storage unit 180, the group ID (group identification information) of a certain group and the login information concerning a service used by a wireless communication apparatus which belongs to the group corresponding to the group ID are stored in association with each other for each user. That is, in the first embodiment, as information indicating the association between the group ID and the terminal ID information, the group information is stored in the group information storage unit 172. Additionally, as information indicating the association between the group ID and the login information, a profile is stored in the profile storage unit 180. That is, in the information processing apparatus (first service provider) 170, the terminal ID information and the login information are associated with each other, and upon receiving terminal ID information from a wireless communication apparatus, the login information associated with the received terminal ID information can be detected. Then, the detected login information is sent to the wireless communication apparatus that has sent the terminal ID information. The items of information indicating the above-described associations are not restricted to the group information and the profile shown in FIGS. 4 and 5, respectively. Alternatively, the profile shown in FIG. 5 to which terminal ID information is added may be stored in the profile storage unit 180.

In the first embodiment, an example in which only wireless communication apparatuses are managed in the device management system is discussed. However, devices owned by users other than wireless communication apparatuses may be registered in the profile, whereby various types of devices may be managed. In this case, too, the terminal ID information and the group ID concerning the corresponding devices may be associated with each other, and the group ID and the login information may be associated with each other.

### [Example of Configuration of Wireless Communication Apparatus]

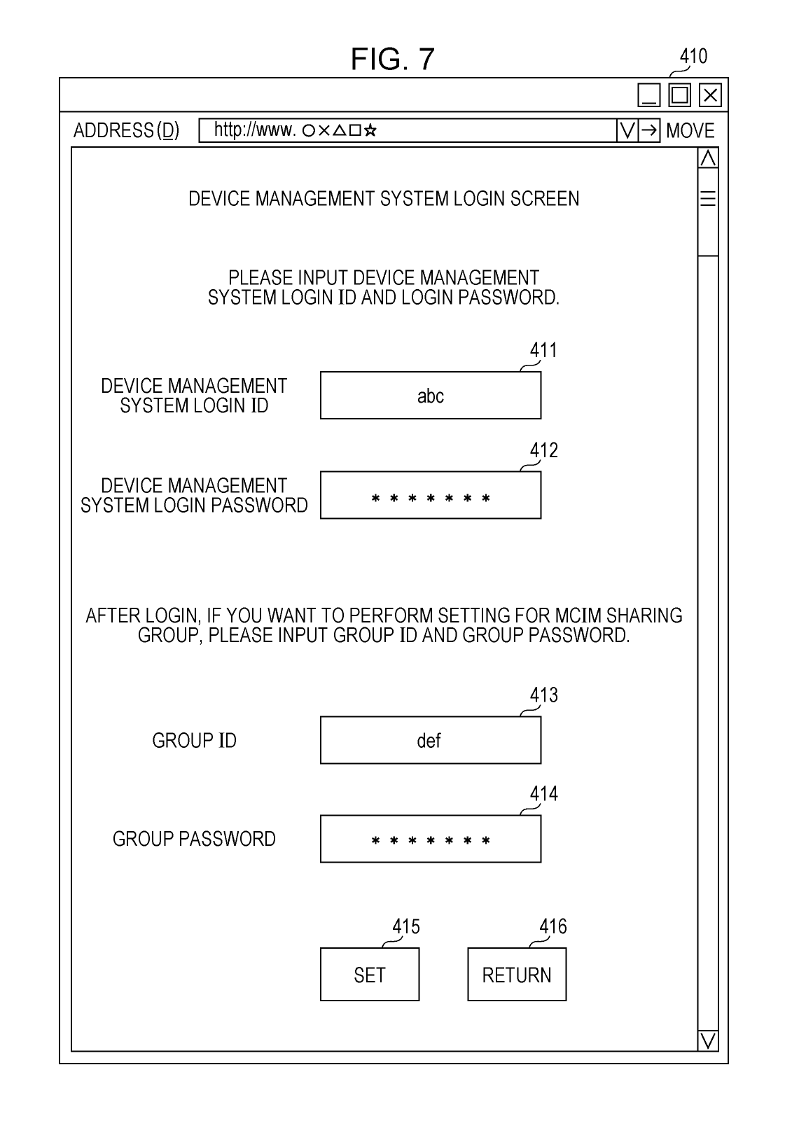

FIG. 6 is a block diagram illustrating an example of the internal configuration of the first wireless communication apparatus 300 in the first embodiment. The internal configuration of the second, third, and fourth wireless communication apparatuses 130, 140, and 150 are similar to that of the first wireless communication apparatus 300, and an explanation thereof will thus be omitted here. In FIGS. 7 through 21, when a description will be given of the second, third, and fourth wireless communication apparatuses 130, 140, and 150, the names and reference numerals of the first wireless communication apparatus 300 will be used.

The first wireless communication apparatus 300 includes an antenna 311, an antenna sharing unit 312, a modulator 321, a demodulator 322, a controller 330, the memory 340, and a MCIM information storage unit 350. The first wireless communication apparatus 300 also includes an operation unit 360, a display unit 370, a position information obtaining unit 380, a microphone 391, and a speaker 392. The operation unit 360, the display unit 370, the position information obtaining unit 380, the microphone 391, and the speaker 392 are connected to one another via a bus 331. The first wireless communication apparatus 300 is implemented by, for example, a mobile phone set that can perform verbal communication and data communication.

For example, when performing reception processing, radio waves received by the antenna 311 are supplied to the demodulator 322 via the antenna sharing unit 312, and are demodulated by the demodulator 322. The demodulated received data is then supplied to the controller 330. If the reception processing is voice reception processing, the demodulated data (sound data) is output from the speaker 392 as sound under the control of the controller 330.

When performing sending processing, for example, sending data output from the controller 330 is modulated by the modulator 321, and the modulated sending data is transmitted through the antenna 311 via the antenna sharing unit 312. If the sending processing is voice sending processing, sound data input through the microphone 391 is modulated by the modulator 321 under the control of the controller 330, and the modulated sending data (sound data) is transmitted through the antenna 311 via the antenna sharing unit 312.

The controller 330 performs various control operations on the basis of a control program stored in the memory 340. The controller 330 is constituted by, for example, a microprocessor. For example, the controller 330 is connected to the modulator 321 and the demodulator 322 so as to send and receive various items of data to and from the communication control apparatus (type II carrier) 120, which is connected to the first wireless communication apparatus 300 via the base station 121 or 122. The controller 330 also performs connecting processing for connecting to the communication control apparatus (type I carrier) 200 via a wireless network through use of restricted connection by using a PCID instead of a MCIM. The controller 330 is an example of a first controller or a second controller.

The memory 340 is a memory in which a control program used for the controller 330 to perform various control operations, transmission data, reception data, etc., are stored. The memory 340 is constituted by a read only memory (ROM) and a random access memory (RAM). In the memory 340, terminal ID information (PCID #1) for specifying the first wireless communication apparatus 300 and a device name (e.g., the device name 224 shown in FIG. 4) of the first wireless communication apparatus 300 are stored. The device name may be registered through a user operation. In the memory 340, the ID and the password (e.g., the group ID 222 and the group password 223 shown in FIG. 4) assigned to the group AB to which the first wireless communication apparatus 300 belongs are also stored. The group ID and the group password are sent from the communication control apparatus (type I carrier) 200 while being included in a group addition authentication result obtained in response to a group addition request, and are stored in the memory 340.

In the memory 340, various items of setting information (e.g., the setting content set in the display screen shown in FIG. 7) are stored.

The MCIM information storage unit 350 is a memory in which a MCIM (contract authentication information) is stored. As the MCIM information storage unit 350, a universal integrated circuit (UICC) card may be used, or a dedicated memory for securing a MCIM may be used. If a UICC card is used, a UICC card which allows a MCIM to be validated/invalidated later is used instead of a card in which a fixed MCIM is stored. That is, a UICC card that allows the controller 330 to validate or invalidate a MCIM on the basis of transfer information received through the antenna 311 and modulated by the modulator 321 is used. Also, a UICC card which is rewritable is used. In order to validate/invalidate a MCIM, validating/invalidating processing defined in 3GPP may be performed. Additionally, by securing a secure region in the memory 340, the MCIM information storage unit 350 may be disposed within the memory 340.

The operation unit 360 receives input operations performed by a user, and outputs a signal corresponding to a received input operation to the controller 330. The operation unit 360 includes various keys, such as numeric keys and alphabet keys.

The display unit 370 displays various items of information, such as text information and time information, under the control of the controller 330. The display unit 370 displays information (e.g., the display screen shown in FIG. 7) for setting various settings. As the display unit 370, a display panel, such as an organic electroluminescence (EL) panel or a liquid crystal display (LCD) panel, may be used. The operation unit 360 and the display unit 370 may be integrated by using a touch panel that allows a user to perform an input operation by bringing a finger into contact with or close to a display screen.

The controller 330 determines whether a wireless communication apparatus (wireless communication apparatus A) in which a connection right to connect to a predetermined network by using wireless communication is not set satisfies a predetermined condition for connecting to the network to perform predetermined communication processing.

If the predetermined condition is satisfied, the controller 330 performs control so that the wireless communication apparatus A performs communication processing by using a connection right which has been transferred from a wireless communication apparatus in which the connection right was set (wireless communication apparatus B).

As a wireless communication apparatus in which a connection right is not set, the second wireless communication apparatus 130 is assumed. In this case, the above-described predetermined condition is a condition that the data amount of photos stored in a built-in memory has exceeded a predetermined capacity or a condition that power is turned OFF immediately after finishing taking photos. That is, the controller 330 of the second wireless communication apparatus 130 determines that the predetermined condition is satisfied at one of the times: (1) when an image content has been generated; (2) when the amount of image content stored in the memory 340 has exceeded a predetermined capacity; and (3) when power is turned OFF or after the lapse of a predetermined period of time after power is turned OFF.

When the controller 330 of the second wireless communication apparatus 130 determines that the predetermined condition is satisfied, it makes a transfer request to transfer a connection right from a wireless communication apparatus B (e.g., the first wireless communication apparatus 300) to the second wireless communication apparatus 130. In this case, the controller 330 makes this request for the communication control apparatus (type I carrier) 200. Then, the controller 330 of the second wireless communication apparatus 130 performs control so that the above-described communication processing is performed by using a connection right set by the communication control apparatus (type II carrier) 120 in response to the transfer request.

More specifically, the controller 330 performs control for executing uploading processing, as communication processing, for uploading generated image content to the information processing apparatus (second service provider) 160.

Upon completing the communication processing (e.g., uploading processing of image content) performed by using a connection right set through the above-described transfer processing, the connection right is transferred back from a transfer destination to a transfer source.

The position information obtaining unit 380 obtains position information indicating a position of the first wireless communication apparatus 300, and outputs the obtained position information to the controller 330. The position information obtaining unit 380 is implemented by, for example, a global positioning system (GPS) unit that calculates a position on the basis of a GPS signal received from a GPS signal reception antenna (not shown). Information concerning the calculated position includes various items of data concerning positions, such as the latitude, longitude, altitude, when a GPS signal has been received. Alternatively, a position information obtaining unit that obtains position information in a different manner may be used. For example, the position may be calculated by using access point information obtained through a wireless local area network (LAN) available around the second wireless communication apparatus 130, and then, position information indicating the calculated position may be obtained.

A description will now be given below of a login screen for logging in to a service (device management system) of the information processing apparatus (first service provider) 170.

### [Display Example of Device Management System Login Screen]

FIG. 7 illustrates an example of a login screen (device management system login screen 410) displayed in the wireless communication apparatus (first wireless communication apparatus 300) when logging in to the device management system in the first embodiment.

In the device management system login screen 410, a login screen displayed on a web browser is schematically shown. In the device management system login screen 410, a description message and input forms 411 and 412 for inputting the ID and the password, respectively, necessary for logging in to the device management system are shown. In the device management system login screen 410, input forms 413 and 414 for inputting the ID (group ID) and the password (group password), respectively, necessary for obtaining group information from the communication control apparatus (type I carrier) 200 are also shown. In this screen, a set button 415 for setting the items of information input into the input forms and for starting a login operation, and a return button 416 for canceling the items of information input into the input forms and for returning the screen to the previous screen are also shown.

In the device management system login screen 410, when pressing the set button 415 after inputting items of information into the input forms 411 and 412, a login to the device management system is performed. In this case, if a login is performed after inputting items of information into the input forms 413 and 414, the controller 171 of the information processing apparatus (first service provider) 170 sends a group information request to the communication unit 205 of the communication control apparatus (type I carrier) 200. That is, the group ID and the group password input into the input forms 413 and 414, respectively, are used for making a request (registration request) for registering group information in the information processing apparatus (first service provider) 170. In the first embodiment, the group information stored in the group information storage unit 172 is updated every time a login is performed after inputting the group ID and the group password into the input forms 413 and 414, respectively.

As shown in FIG. 7, a login to the device management system is performed through a web site. Accordingly, since a web browser is necessary, a communication apparatus with a web browser function is able to perform a login operation. However, a communication apparatus without a web browser function is not able to perform a login operation. In the first embodiment, the first wireless communication apparatus 300 assumed as a tablet device and the fourth wireless communication apparatus 150 assumed as a smartphone are able to perform a login operation. On the other hand, the second wireless communication apparatus 130 assumed as a digital still camera and the third wireless communication apparatus 140 assumed as a portable audio player are not able to perform a login operation.

A description will now be given of a screen for registering an account service in the device management system after logging in to the device management system.

### [Display Example of Device Management System Login Screen]

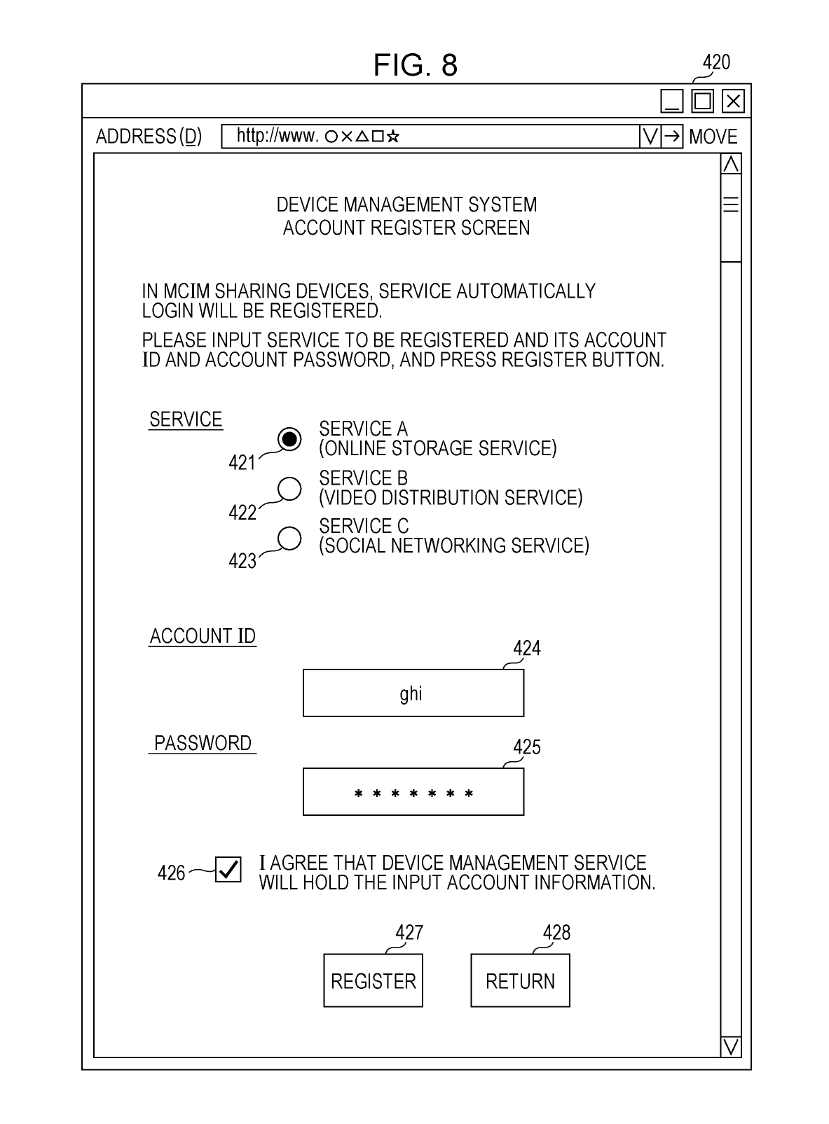

FIG. 8 illustrates an example of a register screen for which an account is managed (hereinafter simply referred to as an “account register screen 420”) displayed in the first wireless communication apparatus 300 when registering an account in the device management system in the first embodiment.

In FIG. 8, a description will be given of an example in which, among three services for which accounts are to be managed (hereinafter referred to as “account management subject services” (service A, service B, and service C), login information concerning service A will be registered. As in FIG. 7, a description will be given by assuming that a screen is displayed on a web browser.

In the account register screen 420, a description message and radio buttons 421, 422, and 423 for selecting a service to be registered are shown. In this screen, input forms 424 and 425 for inputting the login ID (account ID) and the login password (account password) of a service to be registered are also shown. This screen also shows a checkbox 426 for instructing a user to check if the user agrees that input login information will be held in the information processing apparatus (first service provider) 170, a register button 427 for starting registration, and a return button 428 for canceling items of information input into the input forms and for returning the screen to the previous screen.

In the account register screen 420, after selecting a service to be registered by pressing one of the radio buttons 421, 422, and 423 and inputting login information concerning the selected service into the input forms 424 and 425, the register button 427 is pressed, thereby registering the login information. Then, input login information is registered in the management subject login information (see FIG. 5) of the profile of the user who has input the login information among the profiles stored in the profile storage unit 180.

The purpose of use of the registered login information will be discussed. When a wireless communication apparatus (see FIGS. 4 and 5) which belongs to a group of a MCIM owned by the user who has registered the login information accesses the information processing apparatus (first service provider) 170 to obtain login information, the registered login information is supplied to the wireless communication apparatus. Upon receiving the login information, the wireless communication apparatus logs in to a service by using the supplied login information to start the use of the service.

A description will now be given, with reference to FIG. 3, of a process from when a wireless communication apparatus logs in to a service by using the supplied login information until when it starts using the service, assuming that the information processing apparatus (second service provider) 160 is a service provider which supplies the service A (online storage service). In this case, the user first obtains the login information concerning the service A, and then, the user logs in to the device management system in the login screen shown in FIG. 7 and then registers the login information concerning the service A in the account register screen 420 shown in FIG. 8. After registration, before starting the use of the service A, in order to obtain the login information concerning the service A, a wireless communication apparatus belonging to the same group as the first wireless communication apparatus 300 sends a login information request to the information processing apparatus (first service provider) 170.

Upon receiving the login information request, the information processing apparatus (first service provider) 170 specifies a group to which the wireless communication apparatus that has sent the login information request belongs, on the basis of terminal ID information sent from the wireless communication apparatus, and obtains the login information concerning the service A associated with the specified group. The login information is supplied to the wireless communication apparatus only on the basis of terminal ID information (see FIG. 4) and the service ID information (indicating the service A) contained in the login information request supplied from the wireless communication apparatus, and it is not necessary to log in to the information processing apparatus (first service provider) 170. Since a login operation is not necessary, it is possible for a wireless communication apparatus without a web browser function to obtain login information. More specifically, upon receiving a login information request from a wireless communication apparatus, the information processing apparatus (first service provider) 170 searches for a group to which the wireless communication apparatus that has sent the login information request belongs, by using terminal ID information concerning the wireless communication apparatus. That is, from the group management database stored in the group information storage unit 172, the group associated with the terminal ID information concerning the wireless communication apparatus is detected. Then, by using the group ID of the detected group, the profile associated with the group ID is detected from among the profiles stored in the profile storage unit 180. Subsequently, login information concerning the service A associated with the detected profile is sent to the wireless communication apparatus that has sent the login information request.

In FIG. 8, three services (service A, service B, and service C) are shown by way of example, and a service is selected by using a radio button. However, a register screen may be prepared for each service, or a service may be selected from a pull-down menu.

[Example in which Information Processing Apparatus (First Service Provider) Obtains Group Information]

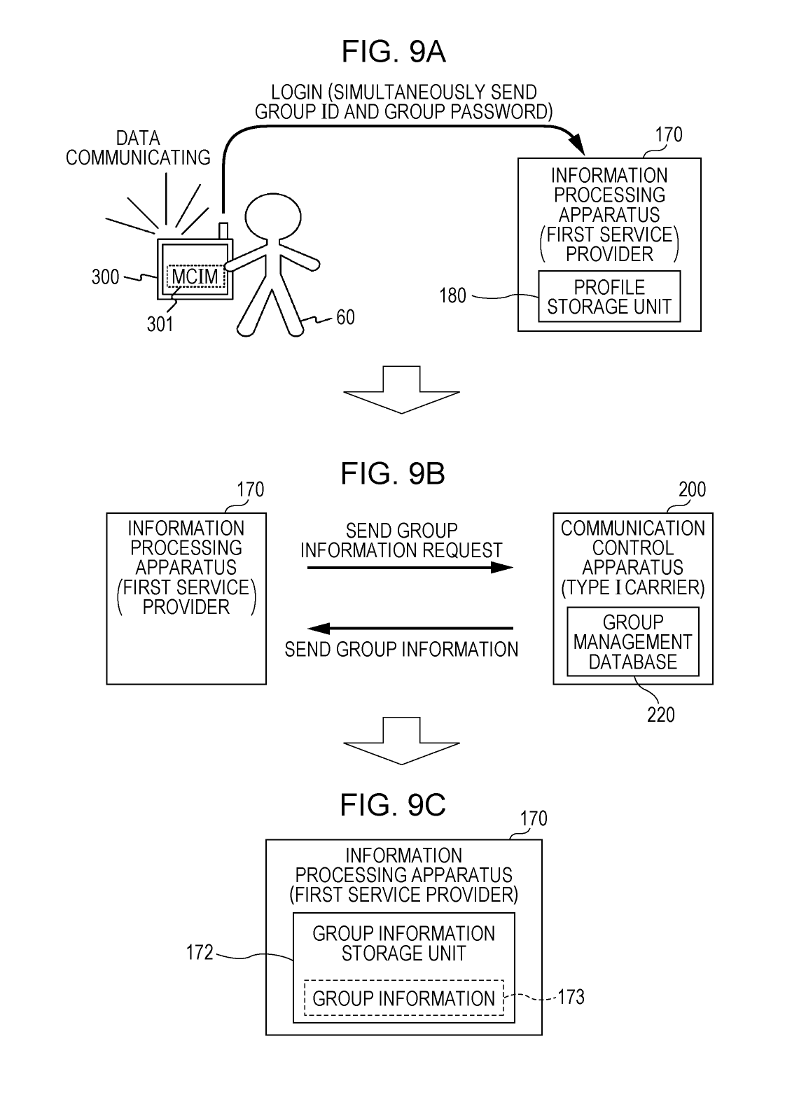

FIGS. 9A through 9C schematically illustrate a process for obtaining group information from the communication control apparatus (type I carrier) 200 by the information processing apparatus (first service provider) 170 in the first embodiment.

FIG. 9A illustrates a state in which the user 60 of the first wireless communication apparatus 300 is performing a login operation by adding a group ID and a group password to login information (ID and password) of the service (device management system) of the information processing apparatus (first service provider) 170. FIG. 9B illustrates a state in which the group ID and the group password are being supplied to the communication control apparatus (type I carrier) 200 and the group information is being supplied from the communication control apparatus (type I carrier) 200 to the information processing apparatus (first service provider) 170. FIG. 9C illustrates a state in which the group information obtained from the communication control apparatus (type I carrier) 200 is being stored in the group information storage unit 172 of the information processing apparatus (first service provider) 170.

As shown in FIG. 9A, when the user 60 performs a login operation on a login screen (see FIG. 7) by inputting a group ID and a group password, the information processing apparatus (first service provider) 170 performs an operation for obtaining group information from the communication control apparatus (type I carrier) 200.

Then, as shown in FIG. 9B, the information processing apparatus (first service provider) 170 sends a group information request including the group ID and the group password which have been input during the login operation to the communication control apparatus (type I carrier) 200. Upon receiving the group information request, the communication control apparatus (type I carrier) 200 obtains, from the group management database 220, group information specified by the group ID and the group password included in the group information request. That is, the communication control apparatus (type I carrier) 200 searches for group information on the basis of the group ID and the group password included in the group information request so as to detect group information that matches both of the group ID and the group password. The communication control apparatus (type I carrier) 200 then sends the detected group information to the information processing apparatus (first service provider) 170.

Then, as shown in FIG. 9C, the information processing apparatus (first service provider) 170 stores the group information supplied from the communication control apparatus (type I carrier) 200 in the group information storage unit 172. If the group information of the group is already stored, it is updated by the group information received from the communication control apparatus (type I carrier) 200.

[Example in which Management Subject Service Login Information is Registered in Information Processing Apparatus (First Service Provider)]

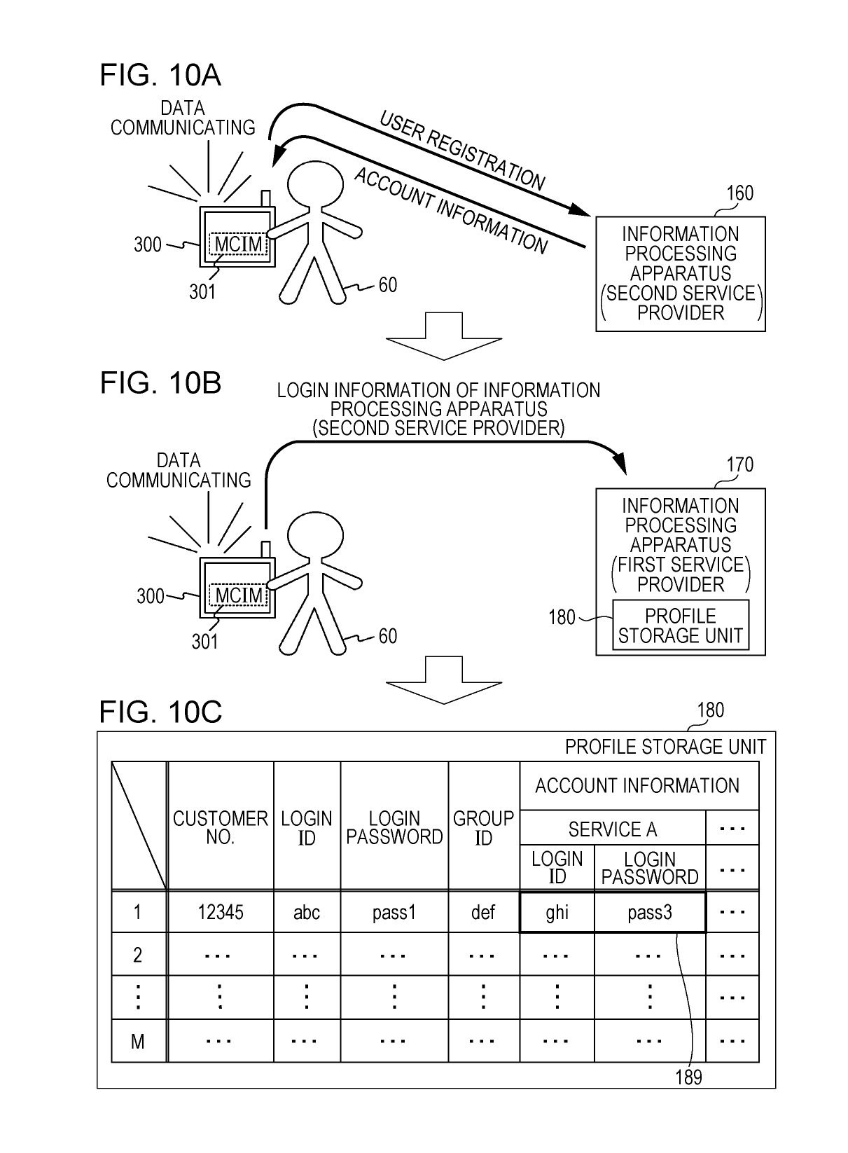

FIGS. 10A through 10C schematically illustrate a process for registering login information concerning a service to be managed in the information processing apparatus (first service provider) 170 by using the first wireless communication apparatus 300 in the first embodiment.

FIG. 10A illustrates a state in which the user 60 of the first wireless communication apparatus 300 is obtaining login information concerning a service to be managed in the device management system. FIG. 10B illustrates a state in which the user 60 of the first wireless communication apparatus 300 registers login information in the information processing apparatus (first service provider) 170. FIG. 10C illustrates a state in which login information is being registered in the profile of the user 60 of the first wireless communication apparatus 300 in the information processing apparatus (first service provider) 170.

As shown in FIG. 10A, the user 60 of the first wireless communication apparatus 300 performs user registration in the information processing apparatus (second service provider) 160 in order to use a service of the information processing apparatus (second service provider) 160. Then, the user 60 of the first wireless communication apparatus 300 obtains login information (login ID and login password) concerning a service of the information processing apparatus (second service provider) 160. It is assumed that this user registration is received only on a web site. That is, the first and fourth wireless communication apparatuses 300 and 150 having a web browser are able to obtain login information, while the second and third wireless communication apparatuses 130 and 140 without a web browser are not able to obtain login information.

Then, as shown in FIG. 10B, the user 60 of the first wireless communication apparatus 300 sends the obtained login information to the information processing apparatus (first service provider) 170.

Then, as indicated by a thick-bordered box 189 in FIG. 10C, the login information sent to the information processing apparatus (first service provider) 170 is registered in the profile of the user 60 of the first wireless communication apparatus 300. That is, the group to which the first wireless communication apparatus 300 belongs and the login information of the information processing apparatus (second service provider) 160 are associated with each other.

[Example in which Service of Information Processing Apparatus (Second Service Provider) is Used]

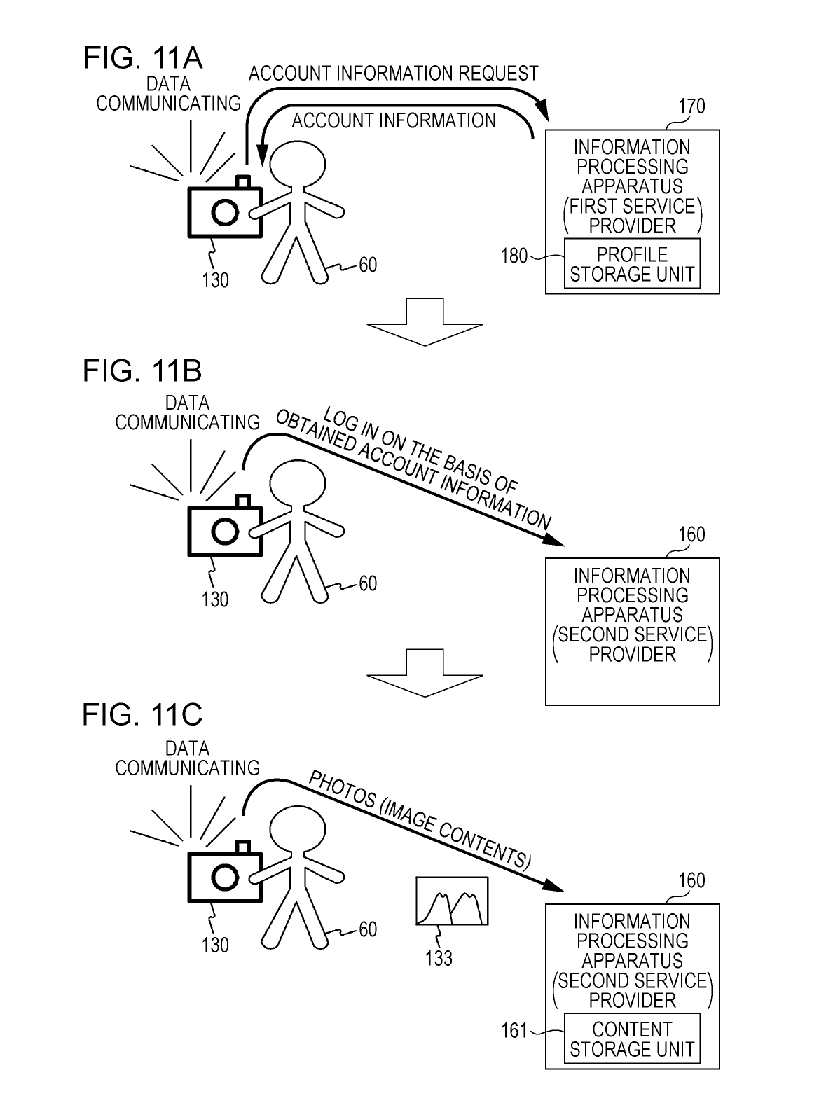

FIGS. 11A through 11C schematically illustrate a process for using a service of the information processing apparatus (second service provider) 160 by using the second wireless communication apparatus 130 in the first embodiment.

FIG. 11A illustrates a state in which the second wireless communication apparatus 130 is obtaining login information stored in the information processing apparatus (first service provider) 170. FIG. 11B illustrates a state in which the second wireless communication apparatus 130 is logging in to a service (online storage service) of the information processing apparatus (second service provider) 160 by using the obtained login information. FIG. 11C illustrates a state in which an image captured by the second wireless communication apparatus 130 is being uploaded to the content storage unit 161 of the information processing apparatus (second service provider) 160.

As shown in FIG. 11A, when using a service of the information processing apparatus (second service provider) 160 by using the second wireless communication apparatus 130, a request to obtain login information concerning this service (login information request) is sent to the information processing apparatus (first service provider) 170. Upon receiving this request, the information processing apparatus (first service provider) 170 detects, on the basis of terminal ID information included in the login information request, group information concerning a group to which the second wireless communication apparatus 130 belongs, among items of group information stored in the group information storage unit 172. The information processing apparatus (first service provider) 170 detects a profile associated with the detected group (group ID) from among the profiles stored in the profile storage unit 180. The information processing apparatus (first service provider) 170 then obtains login information concerning a service of the information processing apparatus (second service provider) 160 in the detected profile, and sends the obtained login information to the second wireless communication apparatus 130.

Then, as shown in FIG. 11B, upon receiving the login information, the second wireless communication apparatus 130 logs in to the service (online storage service) of the information processing apparatus (second service provider) 160 by using the obtained log information.

Then, as shown in FIG. 11C, the second wireless communication apparatus 130 sends a photo (image content 133) to the information processing apparatus (second service provider) 160, and the photo is stored in the content storage unit 161 of the information processing apparatus (second service provider) 160.

In this manner, in the information processing apparatus (first service provider) 170, the group information, terminal ID information concerning a wireless communication apparatus which belongs to a group corresponding to this group information, and login information are associated with one another. With this arrangement, login information can be supplied to the wireless communication apparatus which belongs to this group. A determination as to whether or not login information is supplied to a wireless communication apparatus is made on the basis of terminal ID information (PCID) which is used when setting a MCIM. The forgery of PCID is very difficult. Accordingly, the security of supplying login information is increased.

It is also possible to associate a plurality of wireless communication apparatuses which belong to the same group with login information at one time, which makes it unnecessary to individually register wireless communication apparatuses, thereby facilitating a simple registration operation.

[Example of Communication Processing when Login Information is Registered]

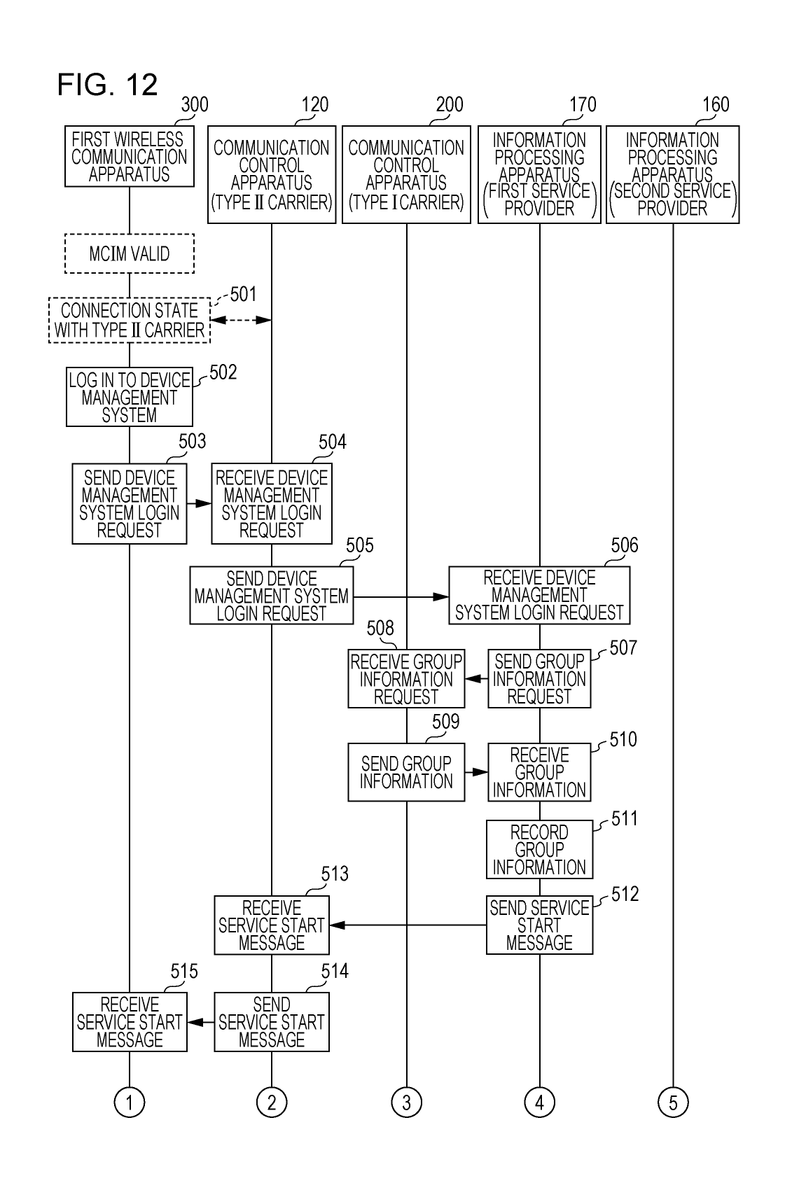

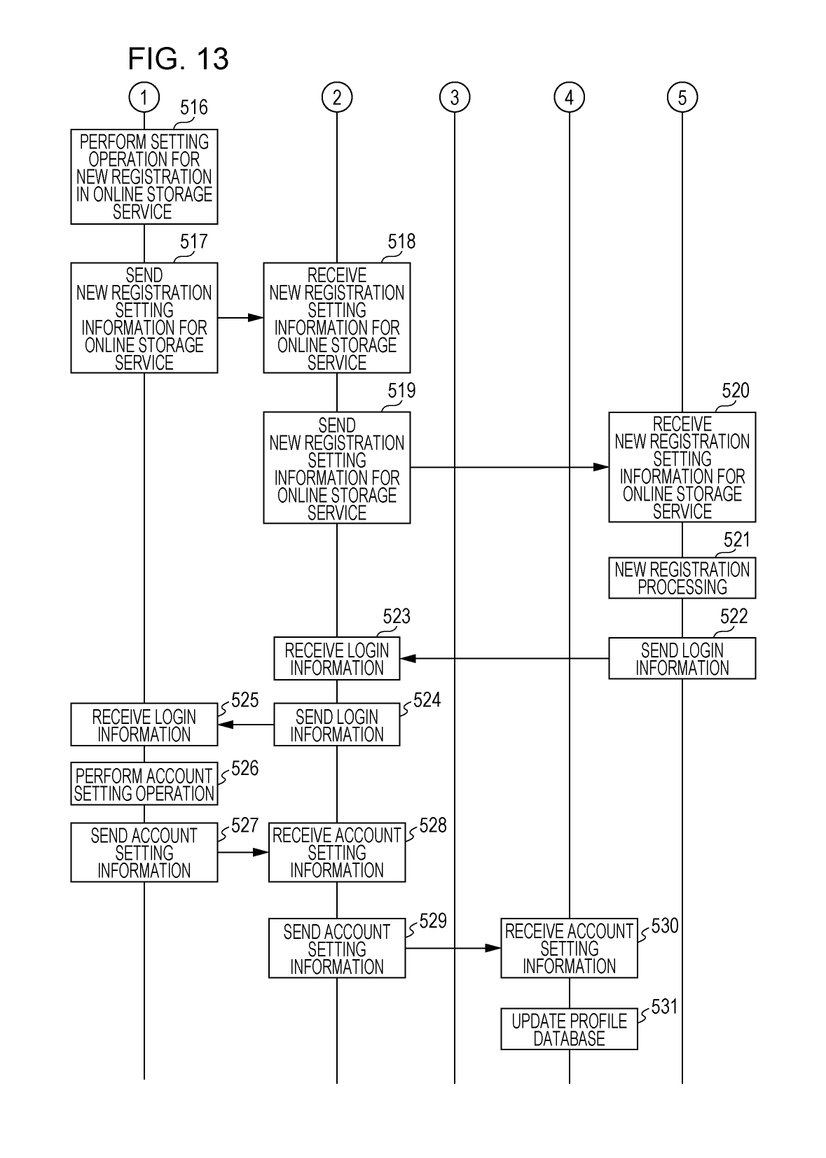

FIGS. 12 and 13 are sequence charts illustrating an example of communication processing performed among the apparatuses forming the communication system 100 of the first embodiment when login information is registered in a profile.

For the sake of description, in FIGS. 12 and 13, a description will be given, assuming that new login information is registered in a service (online storage service) of the information processing apparatus (second service provider) 160 while logging in a service (device management system) of the information processing apparatus (first service provider) 170. In this example, it is assumed that the online storage service and the device management system are operated together and that, when a user registers login information in the online storage service while logging in the device management system, personal information is automatically transferred while saving the user from inputting the personal information again.

Additionally, in FIGS. 12 and 13, a description will be given, assuming that a valid MCIM is stored in the first wireless communication apparatus 300. In FIGS. 12 and 13, an illustration of the second, third, and fourth wireless communication apparatuses 130, 140, and 150 is omitted.

In step S01, the communication control apparatus (type II carrier) 120 and the first wireless communication apparatus 300 are in the connection state. In step S02, the first wireless communication apparatus 300 accesses a login site of the device management system and performs a login operation in the device management system. In this login operation, a site, e.g., the device management system login screen 410 shown in FIG. 7, is displayed, and the first wireless communication apparatus 300 is instructed to send a login ID and a login password of the device management system, a group ID, and a group password.

Then, after inputting items of information into the associated input forms and pressing the set button 415, a device management system login request including the input values is sent to the communication control apparatus (type II carrier) 120 in step S03. Then, the communication control apparatus (type II carrier) 120 receives the request in step S04 and sends it to the information processing apparatus (first service provider) 170 in step 505. Then, in step S06, the information processing apparatus (first service provider) 170 receives the request. The device management system login request is a request for the user of the first wireless communication apparatus 300 to perform a login operation necessary for utilizing the device management system. The device management system login request includes the login ID and the login password of the device management system, the group ID, and the group password. That is, the device management system login request includes the contents input into the input forms 411 through 414 shown in FIG. 7. As stated above, in step S01, the first wireless communication apparatus 300 and the communication control apparatus (type II carrier) 120 are in the connection state. Accordingly, the device management system login request is sent to the information processing apparatus (first service provider) 170 via the communication control apparatus (type II carrier) 120.

Upon receiving the device management system login request in step S06, the controller 171 of the information processing apparatus (first service provider) 170 sends a group information request to the communication control apparatus (type I carrier) 200 in step S07. The group information request is a request for obtaining group information specified by the group ID and the group password included in the device management system login request. The group information request includes at least the group ID and the group password included in the device management system login request.

Upon receiving the group information request by the communication control apparatus (type I carrier) 200 in step S08, the controller 210 of the communication control apparatus (type I carrier) 200 obtains the specified group information from the group management database 220, and sends the specified group information to the information processing apparatus (first service provider) 170 in step 509.

Upon receiving the group information by the information processing apparatus (first service provider) 170 in step S10, the controller 171 of the information processing apparatus (first service provider) 170 stores the received group information in the group information storage unit 172 in step S11. Then, in step S12, the controller 171 of the information processing apparatus (first service provider) 170 sends a service start message indicating that a login has been correctly completed and the use of the device management system is available to the communication control apparatus (type II carrier) 120. The communication control apparatus (type II carrier) 120 receives the service start message in step S13 and sends it to the first wireless communication apparatus 300 in step 514. The first wireless communication apparatus 300 receives the service start message in step S15.

Then, in step S16, the first wireless communication apparatus 300 performs an operation for setting new registration in the online storage service of the information processing apparatus (second service provider) 160. Then, in step S17, the first wireless communication apparatus 300 sends various items of personal information (new registration setting information) to the communication control apparatus (type II carrier) 120. The communication control apparatus (type II carrier) 120 receives the new registration setting information in step S18 and sends it to the information processing apparatus (second service provider) 160 in step S19. Upon receiving the new registration setting information in step S20, the information processing apparatus (second service provider) 160 performs new registration processing for registering the user of the first wireless communication apparatus 300 in step S21.

Then, in step S22, the information processing apparatus (second service provider) 160 sends login information issued as a result of conducting new registration to the communication control apparatus (type II carrier) 120. The communication control apparatus (type II carrier) 120 receives the login information in step S23 and sends it to the first wireless communication apparatus 300 in step S24. The first wireless communication apparatus 300 receives the login information in step S25. The login information includes at least a login ID and a login password necessary for logging in to the service of the information processing apparatus (second service provider) 160.

Then, in step S26, the first wireless communication apparatus 300 accesses a site in which an account service is registered in the device management system, and performs an operation for setting the account. In the account setting operation, a site, e.g., the account register screen 420 shown in FIG. 8, is displayed. In the account setting operation, the user is instructed to select an account service and to input the login ID (account ID) and the login password (account password).

Then, after inputting items of information into the associated input forms of the account register screen 420 and pressing the register button 427, information including the input values (account setting information) is sent to the communication control apparatus (type II carrier) 120 in step S27. Then, the communication control apparatus (type II carrier) 120 receives the account setting information in step S28 and sends it to the information processing apparatus (first service provider) 170 in step 529. The account setting information is information for the user of the first wireless communication apparatus 300 to send account information to be managed by the device management system to the information processing apparatus (first service provider) 170. The account setting information includes at least information for identifying the service and the login ID and the login password of the service. That is, the account setting information includes at least information indicating the selection of one of the radio buttons 421 through 423 and the contents input in the input forms 424 and 425.

Upon receiving the account setting information by the information processing apparatus (first service provider) 170 in step S30, the controller 171 of the information processing apparatus (first service provider) 170 updates the profile database stored in the profile storage unit 180 in step S31. In this updating operation, the login information indicated by the account setting information is registered in the profile of the user to be registered among the profiles stored in the profile storage unit 180. As a result of this updating operation, in the information processing apparatus (first service provider) 170, terminal ID information and login information are associated with each other, and upon receiving terminal ID information from a wireless communication apparatus, the login information associated with the terminal ID information can be supplied to the wireless communication apparatus.

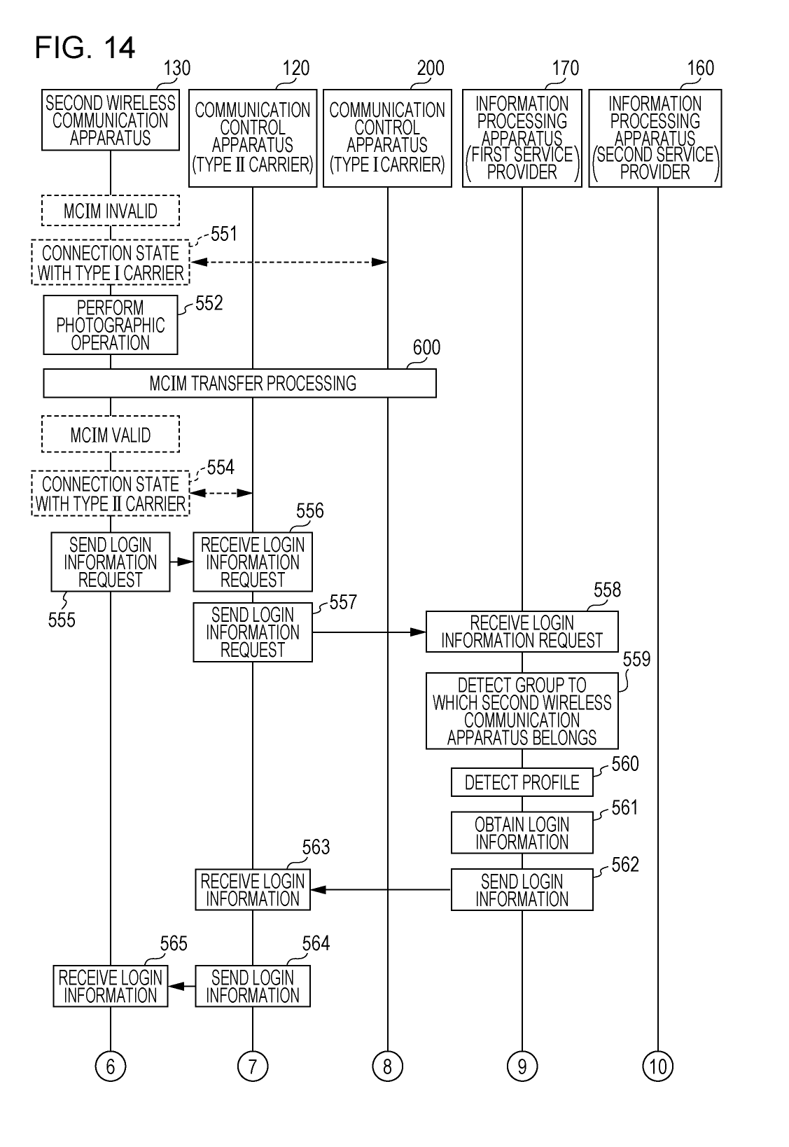

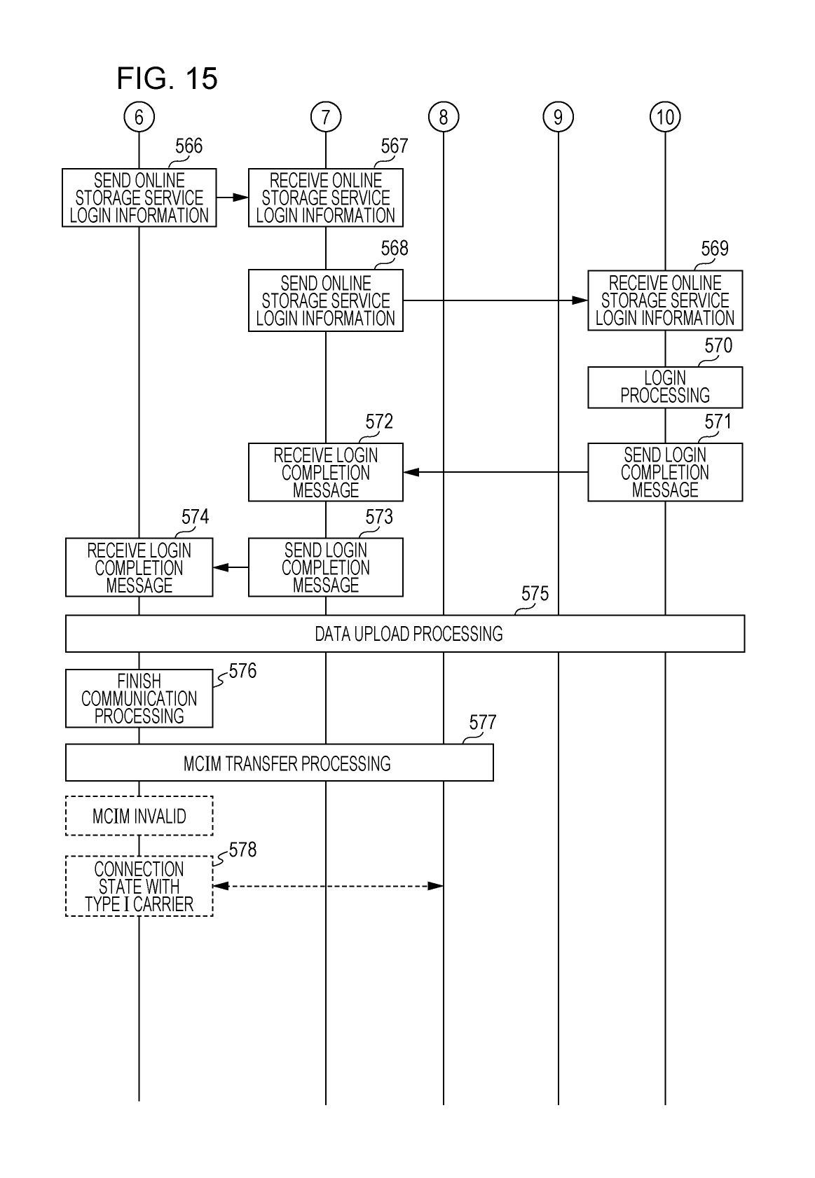

A description will now be given, with reference to FIGS. 14 and 15, of communication processing for utilizing a service of the information processing apparatus (second service provider) 160 by using login information registered in the information processing apparatus (first service provider) 170.

[Example of Communication Processing when Login Information is Used]

FIGS. 14 and 15 are sequence charts illustrating an example of communication processing performed among the apparatuses forming the communication system 100 in the first embodiment when a service is used by obtaining login information.

In FIGS. 14 and 15, an example in which the second wireless communication apparatus 130 uses a service of the information processing apparatus (second service provider) 160 will be discussed. In the example shown in FIGS. 14 and 15, as well as in the example shown in FIGS. 12 and 13, a description will be given, assuming that a valid MCIM is stored in the first wireless communication apparatus 300. That is, a description will be given, assuming that a valid MCIM stored in the first wireless communication apparatus 300 is transferred to the second wireless communication apparatus 130, and then, the second wireless communication apparatus 130 uses a service. In FIGS. 14 and 15, an illustration of the first, third, and fourth wireless communication apparatuses 300, 140, and 150 is omitted.

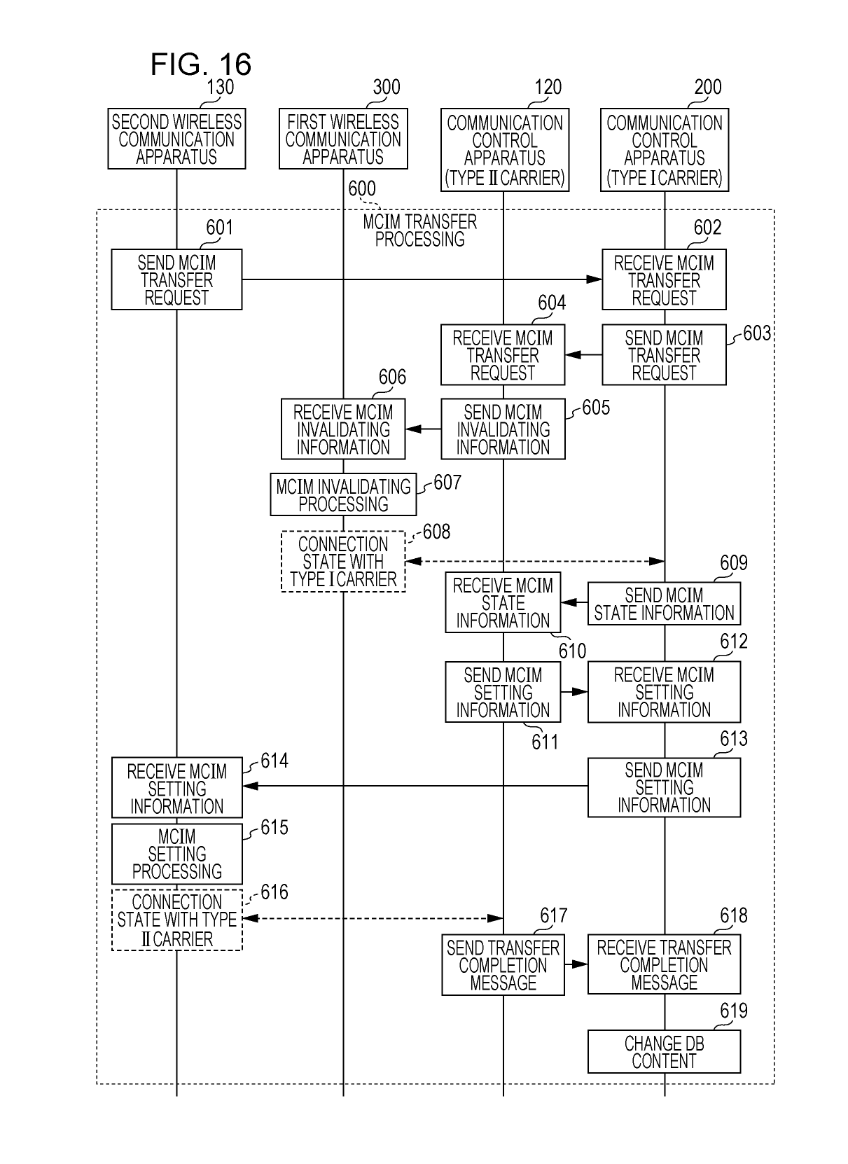

In step S51, the communication control apparatus (type I carrier) 200 and the second wireless communication apparatus 130 are in the connection state. In step S52, the second wireless communication apparatus 130 takes a photo, and then, if it is determined that the use of the online storage service of the information processing apparatus (second service provider) 160 is necessary, MCIM transfer processing is performed in order to use a communication function in step 600. Details of the MCIM transfer processing will be given later with reference to FIG. 16, and thus, an explanation thereof will be omitted here. As a condition for determining that the use of the online storage service is necessary, various conditions may be considered, for example: when the second wireless communication apparatus 130 is running short of the capacity of a data storage region; every time a photo is taken; and when a user gives an instruction to use the online storage service.

After the MCIM transfer processing in step 600, the second wireless communication apparatus 130 is connected to the communication control apparatus (type II carrier) 120 in step S54. Then, in step S55, the second wireless communication apparatus 130 sends a login information request to the communication control apparatus (type II carrier) 120 in order to obtain login information concerning the online storage service from the information processing apparatus (first service provider) 170. The communication control apparatus (type II carrier) 120 receives the login information request in step S56 and sends it to the information processing apparatus (first service provider) 170 in step S57. The login information request includes at least information for identifying a service of the account (information indicating the online storage service) and terminal ID information concerning the second wireless communication apparatus 130. As stated above, since the second wireless communication apparatus 130 and the communication control apparatus (type II carrier) 120 are in the connection state in step S54, the login information request is sent via the communication control apparatus (type II carrier) 120.

Upon receiving the login information request in step 558, in step S59, the information processing apparatus (first service provider) 170 detects a group to which the second wireless communication apparatus 130 belongs, on the basis of the terminal ID information included in the login information request. In this case, from among items of group information stored in the group information storage unit 172 of the information processing apparatus (first service provider) 170, the information processing apparatus (first service provider) 170 detects a group by searching for group information associated with the same terminal ID information as the terminal ID information included in the login information request.

Then, in step S60, the information processing apparatus (first service provider) 170 detects, on the basis of identification information (group ID) concerning the detected group, a profile of the user of the second wireless communication apparatus 130 from among the profiles recorded in the profile storage unit 180. Then, in step S61, the controller 171 of the information processing apparatus (first service provider) 170 obtains online storage service login information registered in the detected profile.

In step S62, the controller 171 of the information processing apparatus (first service provider) 170 sends the obtained login information to the communication control apparatus (type II carrier) 120. Then, the communication control apparatus (type II carrier) 120 receives the login information in step S63 and sends it to the second wireless communication apparatus 130 in step S64.

Upon receiving the login information by the second wireless communication apparatus 130 in step S65, the controller of the second wireless communication apparatus 130 sends the online storage service login information to the communication control apparatus (type II carrier) 120 in step S66. The communication control apparatus (type II carrier) 120 receives the login information in step S67 and sends it to the information processing apparatus (second service provider) 160 in step S68. This login information includes the login ID and the login password contained in the login information supplied from the information processing apparatus (first service provider) 170 to the second wireless communication apparatus 130.

Then, upon receiving the login information in step S69, the information processing apparatus (second service provider) 160 performs login processing for logging in to the online storage service in step S70. Then, in step S71, the information processing apparatus (second service provider) 160 sends a login completion message indicating that a login operation is completed to the communication control apparatus (type II carrier) 120. The communication control apparatus (type II carrier) 120 receives the login completion message in step S72 and sends it to the second wireless communication apparatus 130 in step S73.

Upon receiving the login completion message in step 574, in step S75, the second wireless communication apparatus 130 performs upload processing for uploading a photo (data) and the photo is uploaded to the content storage unit 161 of the information processing apparatus (second service provider) 160.

Then, after completing communication processing in step S76, the MCIM is transferred back from the second wireless communication apparatus 130 to the first wireless communication apparatus 300 in step S77. The MCIM transfer processing in step S77 is similar to that in step 600 shown in FIG. 14, and an explanation thereof is thus omitted.

After the MCIM transfer processing in step S77, the first wireless communication apparatus 300 is connected to the communication control apparatus (type II carrier) 120, and the second wireless communication apparatus 130 is connected to the communication control apparatus (type I carrier) 200 in step S78.

Communication processing for the MCIM transfer processing in step 600 will be discussed below with reference to FIG. 16.

[Example of Communication Processing when MCIM is Transferred]

FIG. 16 is a sequence chart illustrating an example of communication processing performed when transferring a MCIM among the apparatuses forming the communication system 100 in the first embodiment.

In FIG. 16, an illustration of the third and fourth wireless communication apparatuses 140 and 150, the information processing apparatus (first service provider) 170, and the information processing apparatus (second service provider) 160 is omitted.

In the MCIM transfer processing in step 600, the second wireless communication apparatus 130 sends a MCIM transfer request to the communication control apparatus (type I carrier) 200 in step 601. The communication control apparatus (type I carrier) 200 receives the MCIM transfer request in step 602 and sends it to the communication control apparatus (type II carrier) 120 in step 603. As stated above, since the second wireless communication apparatus 130 and the communication control apparatus (type I carrier) 200 are in the connection state in step S51 of FIG. 14, a MCIM transfer request is sent via the communication control apparatus (type I carrier) 200.

Upon receiving the MCIM transfer request by the communication control apparatus (type II carrier) 120 in step 604, the controller 125 of the communication control apparatus (type II carrier) 120 sends MCIM invalidating information to the first wireless communication apparatus 300 in step 605. The MCIM invalidating information is information for invalidating a valid MCIM stored in a wireless communication apparatus. In this case, since the first wireless communication apparatus 300 and the communication control apparatus (type II carrier) 120 are in the connection state, the MCIM invalidating information is directly sent from the communication control apparatus (type II carrier) 120 to the first wireless communication apparatus 300.

Upon receiving the MCIM invalidating information in step 606, the first wireless communication apparatus 300 performs invalidating processing for invalidating the MCIM stored in the MCIM information storage unit 350 in step 607. Then, the MCIM stored in the first wireless communication apparatus 300 is invalidated, and thus, the first wireless communication apparatus 300 is no longer able to connect to the communication control apparatus (type II carrier) 120 on the basis of the MCIM. Accordingly, the first wireless communication apparatus 300 is connected to the communication control apparatus (type I carrier) 200 on the basis of a PCID (restricted connection) in step 608.

In this manner, when a transfer source (first wireless communication apparatus 300) is disconnected from the communication control apparatus (type II carrier) 120 as a result of performing MCIM invalidating processing in the transfer source, the disconnection of the transfer source from the communication control apparatus (type II carrier) 120 is detected by the controller 210 of the communication control apparatus (type I carrier) 200. For example, after performing MCIM invalidating processing, information indicating the execution of the invalidating processing is sent from the transfer source (first wireless communication apparatus 300) to the communication control apparatus (type I carrier) 200, thereby making it possible for the controller 210 to detect the disconnection of the transfer source from the communication control apparatus (type II carrier) 120. Additionally, the controller 210 detects that the transfer source (first wireless communication apparatus 300) is connected to the communication control apparatus (type I carrier) 200 on the basis of a PCID (restricted connection), thereby making it possible for the detector 210 to detect the disconnection of the transfer source from the communication control apparatus (type II carrier) 120.

In this manner, upon detecting the disconnection of the transfer source from the communication control apparatus (type II carrier) 120 by the controller 210, the controller 210 sends MCIM state information to the communication control apparatus (type II carrier) 120 in step 609. This MCIM state information indicates that a valid MCIM is not set in any of the wireless communication apparatuses.

Upon receiving the MCIM state information by the communication control apparatus (type II carrier) 120 in step 610, the controller 125 of the communication control apparatus (type II carrier) 120 sends MCIM setting information to the communication control apparatus (type I carrier) 200 in step 611. The communication control apparatus (type I carrier) 200 then receives the MCIM setting information in step 612 and sends it to the second wireless communication apparatus 130 in step 613. This MCIM setting information is information for setting a valid MCIM in a wireless communication apparatus.

Upon receiving the MCIM setting information by the second wireless communication apparatus 130 in step 614, MCIM setting processing (e.g., validating processing) is performed for setting a valid MCIM in the MCIM information storage unit 350 of the second wireless communication apparatus 130 in step 615. With this processing, a valid MCIM is set in the second wireless communication apparatus 130, and thus, the second wireless communication apparatus 130 is connected to the communication control apparatus (type II carrier) 120 on the basis of the valid MCIM in step 616.

In this manner, upon establishing a connection state between the second wireless communication apparatus 130 and the communication control apparatus (type II carrier) 120 in step 616, the communication control apparatus (type II carrier) 120 sends a transfer completion message to the communication control apparatus (type I carrier) 200 in step 617. The transfer completion message indicates that the MCIM transfer processing is completed. Upon receiving the transfer completion message by the communication control apparatus (type I carrier) 200 in step 618, the controller 210 of the communication control apparatus (type I carrier) 200 updates the content of the group management database 220 (see FIG. 3) in step 619. For example, the validity/invalidity information 226 shown in FIG. 4 corresponding to the first wireless communication apparatus 300 (terminal ID information 225 “PCID #1”) is changed from “valid” to “invalid”. In contrast, the validity/invalidity information 226 corresponding to the second wireless communication apparatus 130 (terminal ID information 225 “PCID #2”) is changed from “invalid” to “valid”.

### [Example of Operation Performed by Communication System]

The operation of the communication system 100 of the first embodiment will be described below with reference to the drawings.

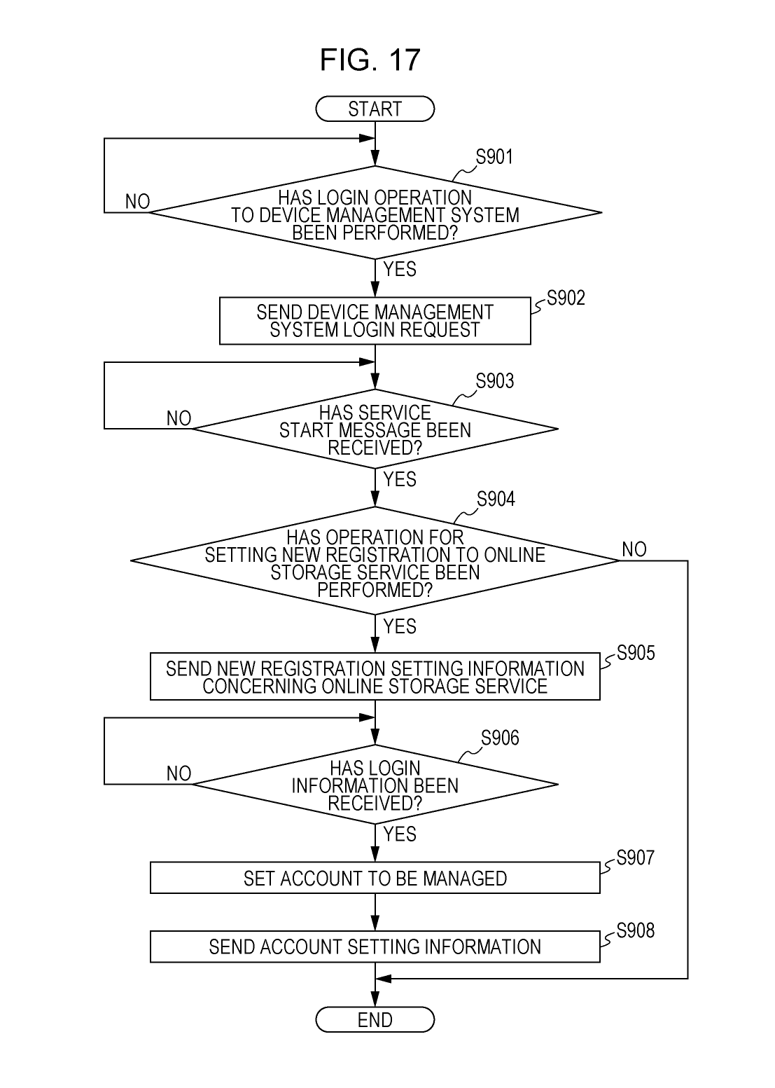

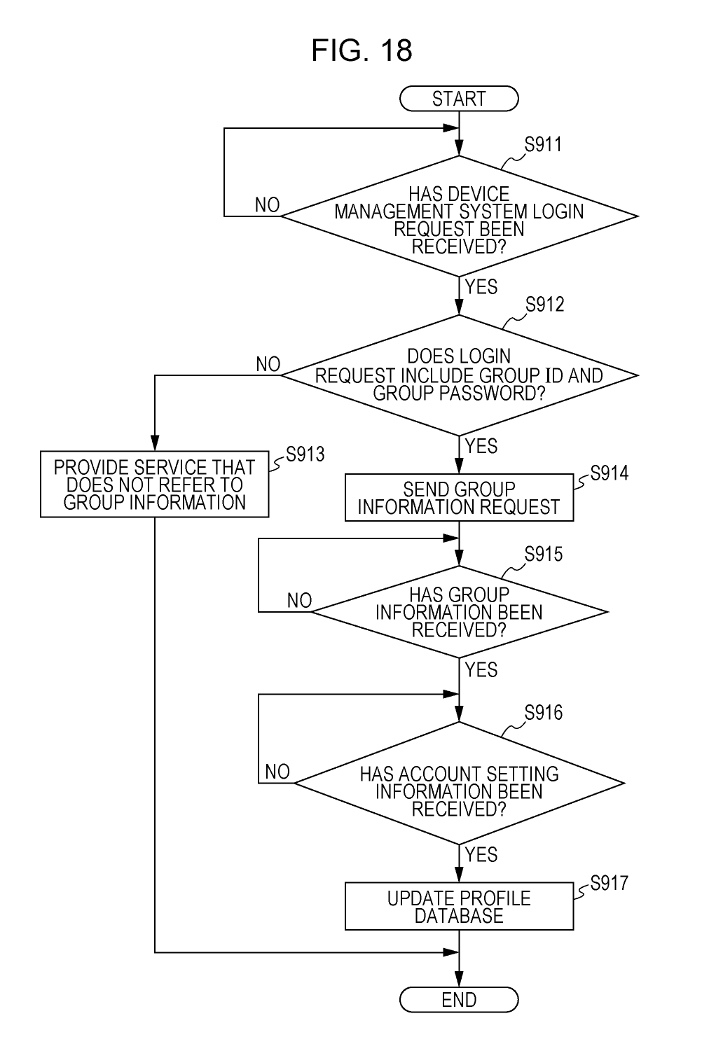

FIGS. 17 and 18 are flowcharts illustrating procedures (processing steps) for performing communication processing by the first wireless communication apparatus 300 and the information processing apparatus (first service provider) 170, respectively, when the first wireless communication apparatus 300 sets management subject service login information.

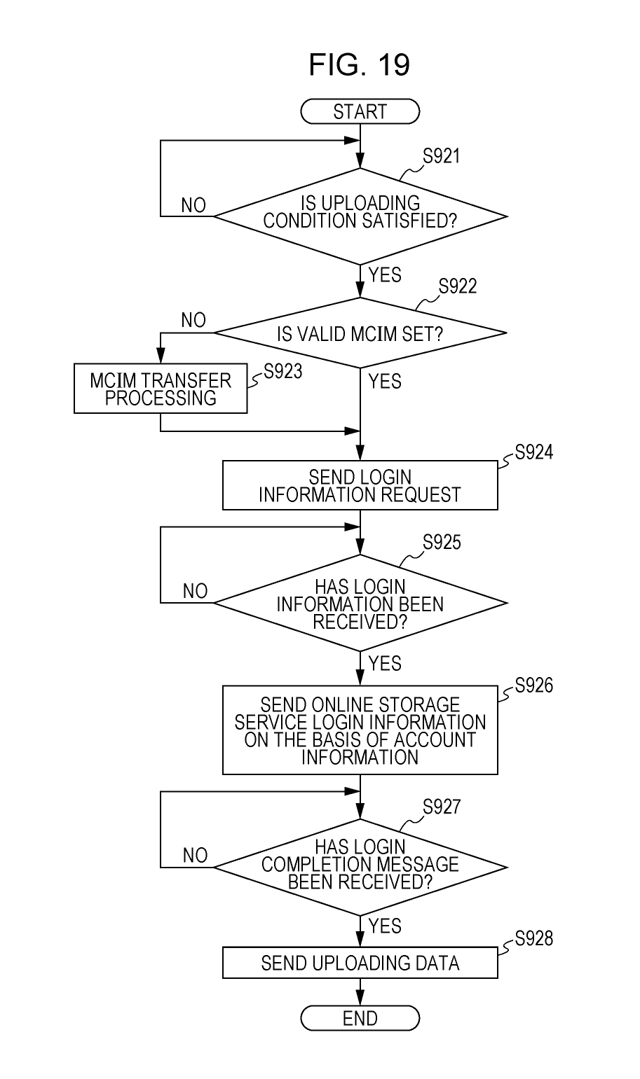

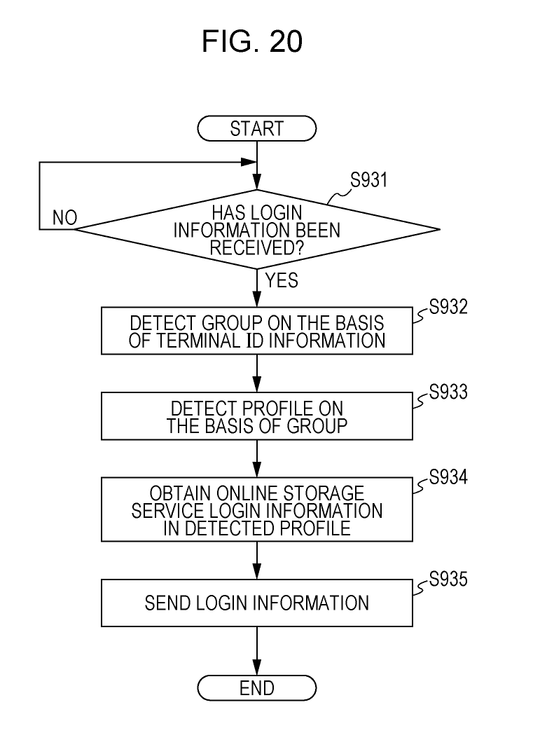

FIGS. 19 and 20 are flowcharts illustrating procedures (processing steps) for performing communication processing by the second wireless communication apparatus 130 and the information processing apparatus (first service provider) 170, respectively, when the second wireless communication apparatus 130 uploads data.

[Example of Operation Performed by Wireless Communication Apparatus when Setting Management Subject Service]

FIG. 17 is a flowchart illustrating an example of a procedure for communication processing performed by the first wireless communication apparatus 300 when setting management subject service login information in the first embodiment. As in FIGS. 12 and 13, in FIG. 17, a description will be given of an example in which, after logging in to a service (device management system) of the information processing apparatus (first service provider) 170, a new registration operation is conducted in a service (online storage service) of the information processing apparatus (second service provider) 160.

In step S901, the controller 330 of the first wireless communication apparatus 300 determines whether a login operation to the device management system has been conducted. If the result of step S901 is NO, the controller 330 enters the standby state in which it waits until a login operation has been conducted.

If the result of step S901 is YES, the process proceeds to step S902. In step S902, a device management system login request is sent to the information processing apparatus (first service provider) 170. The controller 330 then determines in step S903 whether a service start message has been received. If the result of step S903 is NO, the controller 330 enters the standby state in which it waits until a service start message has been received.

If the result of step S903 is YES, the controller 330 proceeds to step S904 to determine whether an operation for setting new registration to the online storage service has been performed. If the result of step S904 is NO, the operation of the communication processing is terminated.

If the result of step S904 is YES, the process proceeds to step S905. In step S905, new registration setting information concerning the online storage service is sent to the information processing apparatus (second service provider) 160. Then, the controller 330 determines in step S906 whether login information has been received. If the result of step S906 is NO, the controller 330 enters the standby state in which it waits until login information has been received.

If the result of step S906 is YES, the process proceeds to step S907. In step S907, an operation for setting an account to be managed is performed. Then, in step S908, the controller 330 sends account setting information to the information processing apparatus (first service provider) 170. The operation of the communication processing is completed.

[Example of Operation Performed by Information Processing Apparatus (First Service Provider) when Setting Management Subject Service]

FIG. 18 is a flowchart illustrating an example of a procedure for communication processing performed by the information processing apparatus (first service provider) 170 when setting a management subject service in the first embodiment.

In step S911, the controller 171 of the information processing apparatus (first service provider) 170 determines whether a device management system login request has been received. If the result of step S911 is NO, the controller 171 enters the standby state in which it waits until a device management system login request has been received.

If the result of step S911 is YES, the controller 171 proceeds to step S912 to determine whether a group ID and a group password are included in the device management system login request. If the result of step S912 is NO, the process proceeds to step S913. In step S913, the controller 171 provides a service which does not refer to group information, and stops the operation of the communication processing.

In contrast, if the result of step S912 is YES, the process proceeds to step S914. In step S914, the controller 171 sends a group information request including a group ID and a group password to the information processing apparatus (first service provider) 170. The controller 171 then determines in step S915 whether group information has been received from the information processing apparatus (first service provider) 170. If the result of step S915 is NO, the controller 171 enters the standby state in which it waits until group information has been received.

If the result of step S915 is YES, the controller 171 proceeds to step S916 to determine whether account setting information has been received from the first wireless communication apparatus 300. If the result of step S916 is NO, the controller 171 enters the standby state in which it waits until account setting information has been received. Step S916 is an example of a step of obtaining device identification information.

If the result of step S916 is YES, the process proceeds to step S917. In step S917, the controller 171 updates the profile database stored in the profile storage unit 180. Then, the operation of the communication processing is completed. Step S917 is an example of a step of performing control.

[Example of Operation Performed by Second Wireless Communication Apparatus when Uploading Data]

FIG. 19 is a flowchart illustrating an example of a procedure for communication processing performed by the second wireless communication apparatus 130 when uploading data (photo).

In the example in FIG. 19, a procedure for communication processing until the second wireless communication apparatus 130 sends uploading data (photo) to the information processing apparatus (second service provider) 160 will be discussed.

In step S921, the controller of the second wireless communication apparatus 130 determines whether a condition for uploading data (condition for using the online storage service) is satisfied. In step S921, if, for example, the space of the data storage region of the second wireless communication apparatus 130 is set as a condition for uploading data, the controller determines that a condition for uploading data is satisfied when the capacity of the data storage region of the second wireless communication apparatus 130 is smaller than a predetermined amount. If the result of step S921 is NO, the controller of the second wireless communication apparatus 130 enters the standby state in which it waits until a condition for uploading data is satisfied.

In contrast, if the result of step S921 is YES, the controller of the second wireless communication apparatus 130 proceeds to step S922 to determine whether a valid MCIM is set in the second wireless communication apparatus 130. If the result of step S922 is NO, the process proceeds to step S923. In step S923, MCIM transfer processing for transferring a valid MCIM set in a wireless communication apparatus which belongs to the same group as that of the second wireless communication apparatus 130 to the second wireless communication apparatus 130 is performed. Then, the process proceeds to step S924.

If the result of step S922 is YES, the process proceeds to step S924. In step S924, the controller of the second wireless communication apparatus 130 sends a login information request for obtaining online storage service login information to the information processing apparatus (first service provider) 170. The controller of the second wireless communication apparatus 130 then determines in step S925 whether the online storage service login information has been received. If the result of step S925 is NO, the controller of the second wireless communication apparatus 130 enters the standby state in which it waits until the online storage service login information has been received.

In contrast, if the result of step S925 is YES, the process proceeds to step S926. In step S926, the controller of the second wireless communication apparatus 130 sends online storage service login information to the information processing apparatus (second service provider) 160. Then, in step S927, the controller of the second wireless communication apparatus 130 determines whether a login completion message sent from the information processing apparatus (second service provider) 160 has been received. If the result of step S927 is NO, the controller of the second wireless communication apparatus 130 enters the standby state in which it waits until a login completion message has been received.

If the result of step S927 is YES, the process proceeds to step S928. In step S928, the controller of the second wireless communication apparatus 130 sends uploading data (photo) to the information processing apparatus (second service provider) 160. The operation of the communication processing is then completed.

[Example of Operation Performed by Information Processing Apparatus (First Service Provider) when Uploading Data]

FIG. 20 is a flowchart illustrating an example of a procedure for communication processing performed by the information processing apparatus (first service provider) 170 when uploading data (photo) in the first embodiment.

In FIG. 20, a procedure for communication processing from when a login information request is received until when login information is sent will be discussed.

In step S931, the controller 171 of the information processing apparatus (first service provider) 170 determines whether a login information request sent from the second wireless communication apparatus 130 has been received. Then, if the result of step S931 is NO, the controller 171 enters the standby state in which it waits until a login information request has been received.

If the result of step S931 is YES, the process proceeds to step S932. In step S932, the controller 171 detects a group (group information) to which the second wireless communication apparatus 130 belongs, on the basis of terminal ID information included in the login information request. Then, in step S933, the controller 171 detects a profile of the user of the second wireless communication apparatus 130 from among the profiles stored in the profile storage unit 180, on the basis of the detected group ID information (group ID). Then, in step S934, the controller 171 obtains the online storage service login information registered in the detected profile.

In step S935, the controller 171 sends the obtained login information to the second wireless communication apparatus 130. The operation of the communication processing is then completed.

As described above, in the first embodiment, by obtaining MCIM group information from an information processing apparatus (first service provider), items of ID information (PC IDs) of a plurality of wireless communication apparatuses and communication service login information can be easily associated with each other. With this arrangement, it is possible to set login information for a plurality of wireless communication apparatuses belonging to the same group at one time, which decreases the load of setting login information, thereby allowing a wireless communication apparatus to easily use a communication service which involves a login operation. Additionally, the login information associated with the ID information can be easily supplied to a wireless communication apparatus, thereby allowing a wireless communication apparatus to easily use a communication service which involves a login operation.

Moreover, when supplying login information to a wireless communication apparatus, the wireless communication apparatus is identified by using a PCID, which is used for the connection to a RO having a high security level, thereby enhancing the security of the device management system.

### 2. Second Embodiment

In the first embodiment of the present technology, an example in which group information to be stored in the group information storage unit 172 of the information processing apparatus (first service provider) 170 is obtained when logging in to the service (device management system) of the information processing apparatus (first service provider) 170 has been discussed. That is, in the first embodiment, a list of wireless communication apparatuses which belong to the same group is stored in the information processing apparatus (first service provider) 170. In this example, upon receiving a login information request, reference is made to the group information (list of wireless communication apparatuses which belong to the same group) stored in the group information storage unit 172, thereby making it possible to perform fast processing. In this example, however, when the group information stored in the group management database 220 is updated, it is also necessary to update the group information stored in the group information storage unit 172. It may be difficult to update the group information stored in the group information storage unit 172 depending on a function of the communication control apparatus (type I carrier) 200. In order to deal with this situation, every time the information processing apparatus (first service provider) 170 has to obtain group information, reference may be made to group information stored in the communication control apparatus (type I carrier) 200.

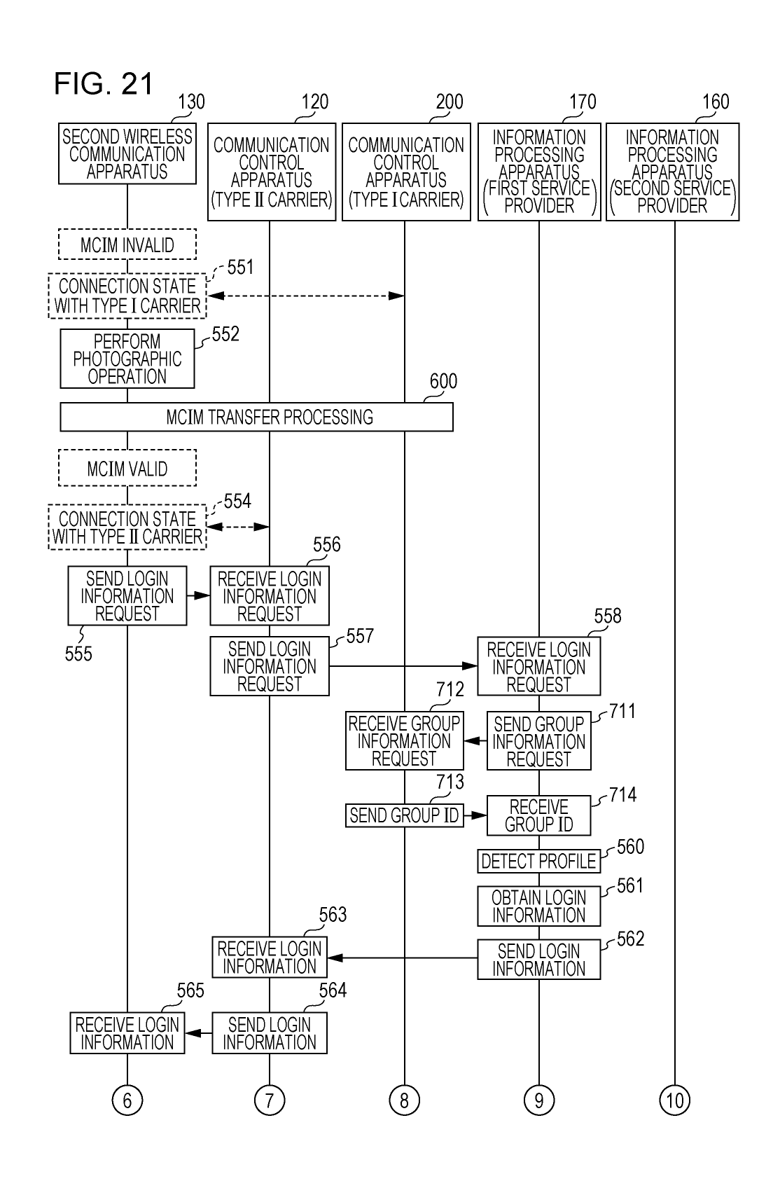

Accordingly, in a second embodiment of the present technology, a description will be given, with reference to FIG. 21, of an example in which every time the information processing apparatus (first service provider) 170 has to obtain group information, reference is made to group information stored in the communication control apparatus (type I carrier) 200.

The functional configuration of the second embodiment is similar to that of the first embodiment, except that the group information storage unit 172 of the information processing apparatus (first service provider) 170 is not provided, and an explanation thereof will thus be omitted. In the second embodiment, a description will be given by focusing on the timing at which reference is made to group information stored in the communication control apparatus (type I carrier) 200. The sequence chart of FIG. 21 indicates this timing.

[Example of Communication Processing when Login Information is Used]

FIG. 21 is a sequence chart illustrating an example of communication processing performed among the apparatuses forming a communication system in the second embodiment when a service is used by obtaining login information.

FIG. 21 is a modified example made to the sequence chart shown in FIG. 14, and FIG. 21 differs from FIG. 14 in that communication processing (steps 711 through 714) for obtaining a group ID by referring to group information is added. Accordingly, in FIG. 21, the same steps as those in FIG. 14 are designated by like step numbers, and an explanation thereof will thus be omitted.

As shown in FIG. 21, in the second embodiment, upon receiving a login information request by the information processing apparatus (first service provider) 170 in step 558, the information processing apparatus (first service provider) 170 sends a group information request to the communication control apparatus (type I carrier) 200 in step 711. The group information request includes terminal ID information contained in the login information request.

Upon receiving the group information request by the communication control apparatus (type I carrier) 200 in step 712, the controller 210 of the communication control apparatus (type I carrier) 200 obtains group information specified by the terminal ID information included in the group information request, on the basis of the terminal ID information. Then, the controller 210 sends information for identifying a group (e.g., group ID) corresponding to the obtained group information to the information processing apparatus (first service provider) 170 in step 713. The information processing apparatus (first service provider) 170 then receives the group ID in step 714, and detects a profile on the basis of the received group ID in step S60.

In this manner, in the second embodiment, every time the information processing apparatus (first service provider) 170 receives a login information request, it obtains MCIM group information from the communication control apparatus (type I carrier) 200. That is, the information processing apparatus (first service provider) 170 does not have to store group information therein, thereby eliminating the necessity of updating group information.

As described above, in the embodiments of the present technology, a wireless communication apparatus is associated with login information by using MCIM group information, which enhances convenience for wireless communication apparatuses when using a communication service which involves a login operation, thereby allowing a user to easily receive a user's favorite communication service.

In the embodiments of the present technology, as a purpose of use of login information, an example in which a photo is uploaded from the second wireless communication apparatus 130 (digital still camera) to an online storage service has been discussed. However, the use of the login information is not restricted to such a purpose. Various other purposes of use may be considered, for example, login information may be used for a service for supplying a photo to a digital photo frame on a regular basis.

In the embodiments of the present technology, an information processing apparatus has been discussed as an integrated apparatus (e.g., communication control apparatus 120 or 200). However, the individual elements (e.g., the controller 210 and the group management database 220) forming an information processing apparatus (e.g., the communication control apparatus 200) may be constituted by a plurality of apparatuses so as to form an information processing system. An embodiment of the present technology may be applied to such an information processing system. Additionally, in the embodiments of the present technology, the group AB constituted by four wireless communication apparatuses has been discussed by way of example. However, an embodiment of the present technology may be applied to a group constituted by two, three, five or more wireless communication apparatuses.

An embodiment of the present technology may be applied to mobile wireless communication apparatuses (e.g., data communication dedicated terminal devices) or fixed wireless communication apparatuses, for example, a wireless communication apparatus used for collecting data of a vending machine or a wireless communication apparatus mounted on an elevator, an automobile, or an electronic device (e.g., a home electric appliance, a game machine, or a digital photo frame).

In the embodiments of the present technology, as a network connection right, a MCIM usage right has been discussed by way of example. Alternatively, a connection right to connect to a predetermined network on the basis of another type of information (e.g., a Universal Subscriber Identity Module (USIM)) may be used.

The above-described embodiments are examples for realizing the present technology, and the elements in the embodiments and the corresponding elements in the claims are associated with each other. Similarly, the elements in the claims and the elements in the embodiments designated by the same names as those in the claims are associated with each other. However, the present technology is not restricted to the disclosed embodiments, and various modifications may be made to the embodiments without departing from the spirit of the present technology.

The processing steps described in the above-described embodiments may be identified as a method including this series of steps, or as a program causing a computer to execute the series of steps or a recording medium storing the program therein. As such a recording medium, a hard disk, a compact disc (CD), a mini disc (MD), a digital versatile disk (DVD), a memory card, a Blu-ray Disc™, etc., may be used.

The present technology may be configured as follows.

(1) An information processing apparatus including:

an obtaining unit configured to obtain, upon receiving, from a wireless communication apparatus which belongs to a group constituted by a plurality of wireless communication apparatuses that share a connection right to connect to a predetermined network by utilizing wireless communication, a registration request to register device identification information for identifying the wireless communication apparatus, device identification information for identifying the plurality of wireless communication apparatuses which belong to the group to which the wireless communication apparatus that has sent the registration request belongs, from a management system which manages the group; and

a controller configured to perform control so that the obtained device identification information and login information are stored in a storage unit in association with each other, the login information being used when a wireless communication apparatus corresponding to the device identification information utilizes a communication service.

(2) The information processing apparatus according to (1), wherein, upon receiving a supply request to supply the login information from a wireless communication apparatus which belongs to the group, the controller supplies the login information associated with device identification information for identifying the wireless communication apparatus that has sent the supply request.

(3) The information processing apparatus according to (2), wherein:

the supply request includes the device identification information;

the management system stores group identification information for identifying a group and the device identification information concerning each of wireless communication apparatuses which belong to the group corresponding to the group identification information in association with each other;

the obtaining unit obtains, upon receiving the registration request, group identification information and the associated device identification information, the group identification information concerning the group to which the wireless communication apparatus that has sent the registration request belongs; and

the controller performs control so that the obtained device identification information and the obtained group identification information are stored in association with each other, and when supplying the login information to the wireless communication apparatus that has sent the supply request, the controller detects group identification information concerning a group to which the wireless communication apparatus that has sent the supply request belongs, on the basis of device identification information included in the supply request, and sends login information associated with the detected group identification information to the wireless communication apparatus that has sent the supply request.

(4) The information processing apparatus according to (3), wherein:

the information processing apparatus is a server that provides a sending service for sending the login information to the wireless communication apparatus; and

in response to a login request to receive the provision of the sending service, the obtaining unit obtains the group identification information and the device identification information if authentication information for changing group information concerning a group to be managed by the management system is supplied.

(5) The information processing apparatus according to one of (1) to (4), wherein:

the management system is a registration operator; and

the obtaining unit obtains, as the device identification information, a provisional connectivity identity used for connecting to the registration operator.

(6) An information processing apparatus including:

a storage unit configured to store group identification information and login information in association with each other, the group identification information being used for identifying a group constituted by a plurality of wireless communication apparatuses that share a connection right to connect to a predetermined network by utilizing wireless communication, the login information being used when a wireless communication apparatus which belongs to the group corresponding to the group identification information utilizes a communication service;

a sending unit configured to send, upon receiving a supply request to supply the login information from a wireless communication apparatus which belongs to the group, device identification information for identifying the wireless communication apparatus, the device identification information being included in the supply request, to a management system in which the group identification information and device identification information concerning each of the wireless communication apparatuses which belong to a group corresponding to the group identification information are stored in association with each other; and

a controller configured to perform control so that, by using group identification information corresponding to the group to which the wireless communication apparatus that has sent the supply request belongs, the group identification information being supplied from the management system in response to the device identification information sent by the sending unit, login information associated with the group identification information is sent to the wireless communication apparatus that has sent the supply request.

(7) A wireless communication apparatus including:

a first controller configured to perform control so that a supply request to supply login information concerning a communication service which involves a login operation when using the communication service, the supply request including device identification information for identifying a wireless communication apparatus, is sent to an information processing apparatus in which the login information and group identification information are stored in association with each other, the group identification information being used for identifying a group constituted by a plurality of wireless communication apparatuses that share a connection right to connect to a predetermined network by utilizing wireless communication; and

a second controller configured to perform control so that, upon receiving, from the information processing apparatus, login information associated with group identification information which has been detected on the basis of the device identification information included in the supply request, a login operation for logging in to the communication service is performed on the basis of the received login information, and then, data concerning the use of the communication service is sent and received.

(8) A communication system including:

a management server configured to store group identification information and device identification information in association with each other for each wireless communication apparatus, the group identification information being used for identifying a group constituted by a plurality of wireless communication apparatuses that share a connection right to connect to a predetermined network by utilizing wireless communication, the device identification information being used for identifying each of the wireless communication apparatuses which belong to the group corresponding to the group identification information, and the management server being configured to manage the group;

an information processing apparatus configured to perform control so that, upon receiving a registration request to obtain the group identification information from a wireless communication apparatus which belongs to the group, the group identification information and the device identification information are obtained from the management server, and so that the obtained group identification information and the obtained device identification information are stored in a storage unit in association with login information which is used when a wireless communication apparatus which belongs to the group corresponding to the obtained group identification information utilizes a communication service; and

a wireless communication apparatus configured to perform control so that, when utilizing the communication service, a registration request to register login information, the registration request including device identification information, is sent to the information processing apparatus, and so that, upon receiving login information which has been detected on the basis of the device identification information from the information processing apparatus, a login operation for logging in to the communication service is performed on the basis of the received login information, and then, data concerning the use of the communication service is sent and received.

(9) A control method for an information processing apparatus, including:

obtaining, upon receiving, from a wireless communication apparatus which belongs to a group constituted by a plurality of wireless communication apparatuses that share a connection right to connect to a predetermined network by utilizing wireless communication, a registration request to register device identification information for identifying the wireless communication apparatus, device identification information for identifying the plurality of wireless communication apparatuses which belong to the group to which the wireless communication apparatus that has sent the registration request belongs, from a management system which manages the group; and

performing control so that the obtained device identification information and login information are stored in a storage unit in association with each other, the login information being used when a wireless communication apparatus corresponding to the device identification information utilizes a communication service.

The present disclosure contains subject matter related to that disclosed in Japanese Priority Patent Application JP 2011-230926 filed in the Japan Patent Office on Oct. 20, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
an obtaining unit configured to obtain, upon receiving, from a wireless communication apparatus which belongs to a group constituted by a plurality of wireless communication apparatuses that share a connection right to connect to a predetermined network by utilizing wireless communication, a registration request to register device identification information for identifying the wireless communication apparatus, device identification information for identifying the plurality of wireless communication apparatuses which belong to the group to which the wireless communication apparatus that has sent the registration request belongs, from a management system which manages the group; and
a controller configured to perform control so that the obtained device identification information and login information are stored in a storage unit in association with each other, the login information being used when a wireless communication apparatus corresponding to the device identification information utilizes a communication service.

2. The information processing apparatus according to claim 1, wherein, upon receiving a supply request to supply the login information from a wireless communication apparatus which belongs to the group, the controller supplies the login information associated with device identification information for identifying the wireless communication apparatus that has sent the supply request.

3. The information processing apparatus according to claim 2, wherein:
the supply request includes the device identification information;
the management system stores group identification information for identifying a group and the device identification information concerning each of wireless communication apparatuses which belong to the group corresponding to the group identification information in association with each other;
the obtaining unit obtains, upon receiving the registration request, group identification information and the associated device identification information, the group identification information concerning the group to which the wireless communication apparatus that has sent the registration request belongs; and
the controller performs control so that the obtained device identification information and the obtained group identification information are stored in association with each other, and when supplying the login information to the wireless communication apparatus that has sent the supply request, the controller detects group identification information concerning a group to which the wireless communication apparatus that has sent the supply request belongs, on the basis of device identification information included in the supply request, and sends login information associated with the detected group identification information to the wireless communication apparatus that has sent the supply request.

4. The information processing apparatus according to claim 3, wherein:
the information processing apparatus is a server that provides a sending service for sending the login information to the wireless communication apparatus; and
in response to a login request to receive the provision of the sending service, the obtaining unit obtains the group identification information and the device identification information if authentication information for changing group information concerning a group to be managed by the management system is supplied.

5. The information processing apparatus according to claim 1, wherein:
the management system is a registration operator; and
the obtaining unit obtains, as the device identification information, a provisional connectivity identity used for connecting to the registration operator.

6. An information processing apparatus comprising:
a storage unit configured to store group identification information and login information in association with each other, the group identification information being used for identifying a group constituted by a plurality of wireless communication apparatuses that share a connection right to connect to a predetermined network by utilizing wireless communication, the login information being used when a wireless communication apparatus which belongs to the group corresponding to the group identification information utilizes a communication service;
a sending unit configured to send, upon receiving a supply request to supply the login information from a wireless communication apparatus which belongs to the group, device identification information for identifying the wireless communication apparatus, the device identification information being included in the supply request, to a management system in which the group identification information and device identification information concerning each of the wireless communication apparatuses which belong to a group corresponding to the group identification information are stored in association with each other; and
a controller configured to perform control so that, by using group identification information corresponding to the group to which the wireless communication apparatus that has sent the supply request belongs, the group identification information being supplied from the management system in response to the device identification information sent by the sending unit, login information associated with the group identification information is sent to the wireless communication apparatus that has sent the supply request.

7. A wireless communication apparatus comprising:
a first controller configured to perform control so that a supply request to supply login information concerning a communication service which involves a login operation when using the communication service, the supply request including device identification information for identifying a wireless communication apparatus, is sent to an information processing apparatus in which the login information and group identification information are stored in association with each other, the group identification information being used for identifying a group constituted by a plurality of wireless communication apparatuses that share a connection right to connect to a predetermined network by utilizing wireless communication; and
a second controller configured to perform control so that, upon receiving, from the information processing apparatus, login information associated with group identification information which has been detected on the basis of the device identification information included in the supply request, a login operation for logging in to the communication service is performed on the basis of the received login information, and then, data concerning the use of the communication service is sent and received.

8. A communication system comprising:
a management server configured to store group identification information and device identification information in association with each other for each wireless communication apparatus, the group identification information being used for identifying a group constituted by a plurality of wireless communication apparatuses that share a connection right to connect to a predetermined network by utilizing wireless communication, the device identification information being used for identifying each of the wireless communication apparatuses which belong to the group corresponding to the group identification information, and the management server being configured to manage the group;
an information processing apparatus configured to perform control so that, upon receiving a registration request to obtain the group identification information from a wireless communication apparatus which belongs to the group, the group identification information and the device identification information are obtained from the management server, and so that the obtained group identification information and the obtained device identification information are stored in a storage unit in association with login information which is used when a wireless communication apparatus which belongs to the group corresponding to the obtained group identification information utilizes a communication service; and
a wireless communication apparatus configured to perform control so that, when utilizing the communication service, a registration request to register login information, the registration request including device identification information, is sent to the information processing apparatus, and so that, upon receiving login information which has been detected on the basis of the device identification information from the information processing apparatus, a login operation for logging in to the communication service is performed on the basis of the received login information, and then, data concerning the use of the communication service is sent and received.

9. A control method for an information processing apparatus, comprising:
obtaining, upon receiving, from a wireless communication apparatus which belongs to a group constituted by a plurality of wireless communication apparatuses that share a connection right to connect to a predetermined network by utilizing wireless communication, a registration request to register device identification information for identifying the wireless communication apparatus, device identification information for identifying the plurality of wireless communication apparatuses which belong to the group to which the wireless communication apparatus that has sent the registration request belongs, from a management system which manages the group; and
performing control so that the obtained device identification information and login information are stored in a storage unit in association with each other, the login information being used when a wireless communication apparatus corresponding to the device identification information utilizes a communication service.
